(19) United States
(12) Patent Application Publication
(10) Pub. No.: US 2019/0285896 A1
(43) Pub. Date: Sep. 19, 2019

(54) TRANSMISSION-TYPE HEAD MOUNTED DISPLAY APPARATUS, METHOD OF CONTROLLING TRANSMISSION-TYPE HEAD MOUNTED DISPLAY APPARATUS, AND COMPUTER PROGRAM FOR CONTROLLING TRANSMISSION-TYPE HEAD MOUNTED DISPLAY APPARATUS

(71) Applicant: SEIKO EPSON CORPORATION, Tokyo (JP)

(72) Inventors: Shinichi KOBAYASHI, AZUMINO-SHI (JP); Masahide TAKANO, MATSUMOTO-SHI (JP)

(73) Assignee: SEIKO EPSON CORPORATION, Tokyo (JP)

(21) Appl. No.: 16/356,901

(22) Filed: Mar. 18, 2019

(30) Foreign Application Priority Data
Mar. 19, 2018 (JP) 2018-050596

(51) Int. Cl. G02B 27/01; G06F 3/01; G06T 19/00; G06F 3/03

(52) U.S. Cl. CPC G02B 27/0172; G06F 3/017; G06T 19/006; G02B 2027/0198; G02B 2027/0178; G02B 2027/014; G02B 2027/0138; G06F 3/0304

(57) ABSTRACT

A transmission-type head mounted display apparatus includes: an image display unit configured to transmit an external scene and display an image on the external scene; and a controller configured to control the image display unit, wherein the controller is configured to perform: target acquisition processing for acquiring a position range of one or more target objects included in the external scene; coordinate acquisition processing for acquiring a direction set in accordance with an instruction by a user and an instruction region positioned closest to the user among instruction regions which are portions common with the position range of one or more target objects; and display processing for displaying, on the image display unit, an image corresponding to a specific object being the target object, the position range of which includes the instruction region.

### BACKGROUND

### 1. Technical Field

The present invention relates to a transmission-type head mounted display apparatus, a method of controlling the transmission-type head mounted display apparatus, and a computer program for controlling the transmission-type head mounted display apparatus.

### 2. Related Art

There has been known a transmission-type head mounted display apparatus which includes an imaging unit for imaging an external scene, and image determination processing for determining whether a target object is a target to be controlled by comparing a stored image and the captured target object, and displaying an image on a display device together with the external scene (for example, JP-A-2016-148968).

With such head mounted display apparatus, in a case where a plurality of target objects to be controlled are captured on one imaging screen, image determination for comparing the respective target objects and stored images may be performed at the same time. As a result, control of target objects, which is not intended by a user, is performed, and an image unnecessary for the user is displayed on the display device. Therefore, a head mounted display apparatus for performing control of a target object specified by the user has been desired.

### SUMMARY

According to a mode of the present invention, a transmission-type head mounted display apparatus is provided. The transmission-type head mounted display apparatus includes an image display unit configured to transmit an external scene and display an image on the external scene, and a controller configured to control the image display unit. The controller is configured to perform target acquisition processing for acquiring a position range of one or more target objects included in the external scene, coordinate acquisition processing for acquiring a direction set in accordance with an instruction by a user and an instruction region positioned closest to the user among instruction regions which are portions positionally identical to the position range of the one or more target objects, and display processing for allowing display of an image associated with a specific object being the target object, the position range of which includes the instruction region, on the image display unit.

### BRIEF DESCRIPTION OF THE DRAWINGS

The invention will be described with reference to the accompanying drawings, wherein like numbers reference like elements.

FIG. 1 is an explanatory diagram illustrating an external configuration of a transmission-type head mounted display apparatus.

FIG. 2 is a plan view illustrating a configuration of a main part of an optical system included in an image display unit.

FIG. 3 is a diagram illustrating a configuration of a main part of the image display unit as viewed from a user.

FIG. 4 is a diagram illustrating an angle of view of an imaging unit.

FIG. 5 is a functional block diagram illustrating a configuration of an HMD.

FIG. 6 is a functional block diagram illustrating a configuration of a controller.

FIG. 7 is a schematic diagram illustrating a part of target object data stored in a storage unit of a storage function unit.

FIG. 8A is a perspective diagram illustrating a target instruction device to be used by the user.

FIG. 8B is a schematic explanatory diagram illustrating correction of a position of a cross point by a coordinate acquisition unit.

FIG. 9 is a flowchart of control performed by a controller.

FIG. 10 is an explanatory diagram illustrating an example of a visual field that the user visually recognizes through the image display unit.

FIG. 11 is an explanatory diagram illustrating an example of the visual field in a case where the user uses the target instruction device.

FIG. 12 is a schematic explanatory diagram illustrating a first confirmation operation by the user.

FIG. 13 is an explanatory diagram illustrating an example of a maximum region under a state in which an imaging control unit performs specific display processing.

FIG. 14 is an explanatory diagram illustrating an example of the maximum region in which a pointer marker is displayed on a visual object.

FIG. 15 is a schematic explanatory diagram illustrating a second confirmation operation by the user.

FIG. 16 is an explanatory diagram illustrating a maximum region under a state in which the imaging control unit performs second specific display processing.

FIG. 17 is an explanatory diagram illustrating an example of the maximum region under a state in which the pointer marker is displayed.

FIG. 18 is an explanatory diagram illustrating a visual field in a case where control of an air-conditioner operation panel is performed.

### DESCRIPTION OF EXEMPLARY EMBODIMENTS

### A. First Exemplary Embodiment

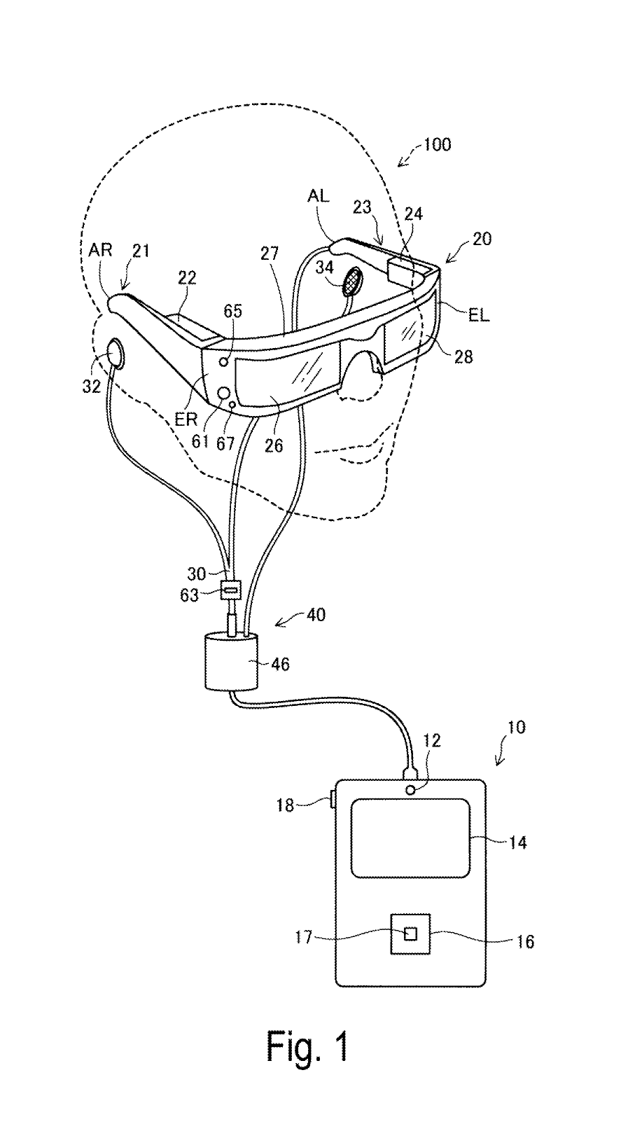

FIG. 1 is an explanatory diagram illustrating an external configuration of a transmission-type head mounted display apparatus 100. The head mounted display apparatus 100 is a display apparatus to be mounted on a user's head and is also referred to as a Head Mounted Display (HMD). The HMD 100 is a transmission type (see-through type) head- mounted display apparatus that provides an image appearing in an external scene visually recognized through glasses.

The HMD 100 includes an image display unit 20 configured to allow the user to visually recognize images and a controller 10 configured to control the image display unit 20.

An image display unit 20 is a head-mounted body to be worn by the user on the head and has an eyeglasses-like shape in the exemplary embodiment. The image display unit 20 includes a support body including a right holding portion 21, a left holding portion 23, and a front frame 27 and further includes, on the support body, a right display unit 22, a left display unit 24, a right light-guiding plate 26, and a left light-guiding plate 28.

The right holding portion 21 and the left holding portion 23 respectively extend rearward from ends of the front frame 27 to hold the image display unit 20 on the user's head in a manner similar to the temples of a pair of eyeglasses. Here, one of the ends of the front frame 27 located on the right side of the user when the user wears the image display unit 20 is referred to as an end ER, and the other end located on the left side of the user when the user wears the image display unit 20 is referred to as an end EL. The right holding portion 21 is provided to extend from the end ER of the front frame 27 to a position corresponding to the right temple of the user when the user wears the image display unit 20. The left holding portion 23 is provided to extend from the end EL of the front frame 27 to a position corresponding to the left temple of the user when the user wears the image display unit 20.

The right light-guiding plate 26 and the left light-guiding plate 28 are provided in the front frame 27. The right light-guiding plate 26 is positioned in front of the right eye of the user, when the user wears the image display unit 20, to allow the right eye to view an image. The left light-guiding plate 28 is positioned in front of the left eye of the user, when the user wears the image display unit 20, to allow the left eye to view an image.

The front frame 27 has a shape connecting an end of the right light-guiding plate 26 and an end of the left light-guiding plate 28 with each other. The position of connection corresponds to a position between eyebrows of the user when the user wears the image display unit 20. The front frame 27 may include a nose pad portion that is provided at the position of connection between the right light-guiding plate 26 and the left light-guiding plate 28, and that is in contact with the nose of the user when the user wears the image display unit 20. In this case, the nose pad portion, the right holding portion 21, and the left holding portion 23 allow the image display unit 20 to be held on the head of the user. A belt may also be attached to the right holding portion 21 and the left holding portion 23 that fits to the back of the head of the user when the user wears the image display unit 20. In this case, the belt allows the image display unit 20 to be firmly held on the head of the user.

The right display unit 22 is configured to display images on the right light-guiding plate 26. The right display unit 22 is provided on the right holding portion 21 and lies adjacent to the right temple of the user when the user wears the image display unit 20. The left display unit 24 is configured to display images on the left light-guiding plate 28. The left display unit 24 is provided on the left holding portion 23 and lies adjacent to the left temple of the user when the user wears the image display unit 20. Note that the right display unit 22 and the left display unit 24 are also collectively referred to as a “display driving unit”.

The right light-guiding plate 26 and the left light-guiding plate 28 according to the exemplary embodiment are optical parts (e.g., prisms) formed of a light transmission-type resin or the like, and are configured to guide image light output by the right display unit 22 and the left display unit 24 to the eyes of the user. Surfaces of the right light-guiding plate 26 and the left light-guiding plate 28 may be provided with dimmer plates. The dimmer plates are thin-plate optical elements having a different transmittance for a different wavelength range of light, and function as so-called wavelength filters. The dimmer plates are arranged to cover a surface of the front frame 27 (a surface opposite to a surface facing the eyes of the user), for example. Appropriate selection of optical property of the dimmer plates allows the transmittance of light to a desired wavelength range, such as visible light, infrared light, and ultraviolet light to be adjusted, and allows the amount of outside light entering the right light-guiding plate 26 and the left light-guiding plate 28 and passing through the right light-guiding plate 26 and the left light-guiding plate 28 to be adjusted.

The image display unit 20 is an image display unit configured to transmit an external scene (outside scene) and display an image on the external scene. The image display unit 20 is configured to guide imaging light generated by the right display unit 22 and the left display unit 24 to the right light-guiding plate 26 and the left light-guiding plate 28, respectively, and to use this imaging light to cause the user to visually recognize an image (augmented reality (AR) image) (which is also referred to as “to display an image”). In a case where the outside light traveling from the front of the user passes through the right light-guiding plate 26 and the left light-guiding plate 28 and enters the eyes of the user, the image light forming an image and the outside light enter the eyes of the user. The visibility of images viewed by the user can be affected by the intensity of the outside light.

The visibility of images may thus be adjusted, for example, by mounting dimmer plates on the front frame 27 and by appropriately selecting or adjusting the optical properties of the dimmer plates. In a typical example, dimmer plates may be selected to have a light transmittance to allow the user with the HMD 100 to visually recognize at least an external scene. The use of the dimmer plates is also expected to be effective in protecting the right light-guiding plate 26 and the left light-guiding plate 28 to prevent, for example, damage and adhesion of dust to the right light-guiding plate 26 and the left light-guiding plate 28. The dimmer plates may be removably attached to the front frame 27 or each of the right light-guiding plate 26 and the left light-guiding plate 28. Alternatively, different types of removable dimmer plates may be provided for replacement, or alternatively the dimmer plates may be omitted.

An imaging unit 61 is a digital camera including an imaging lens and an imaging element such as a CCD and a CMOS, and being capable of imaging a still image and a moving image. The imaging unit 61 is arranged on the front frame 27 of the image display unit 20. The imaging unit 61 is provided on a front surface of the front frame 27 and positioned so that the imaging unit 61 does not block the outside light passing through the right light-guiding plate 26 and the left light-guiding plate 28. In the example in FIG. 1, the imaging unit 61 is arranged on the end ER of the front frame 27. The imaging unit 61 may be arranged on the end EL of the front frame 27 or at the connection between the right light-guiding plate 26 and the left light-guiding plate 28.

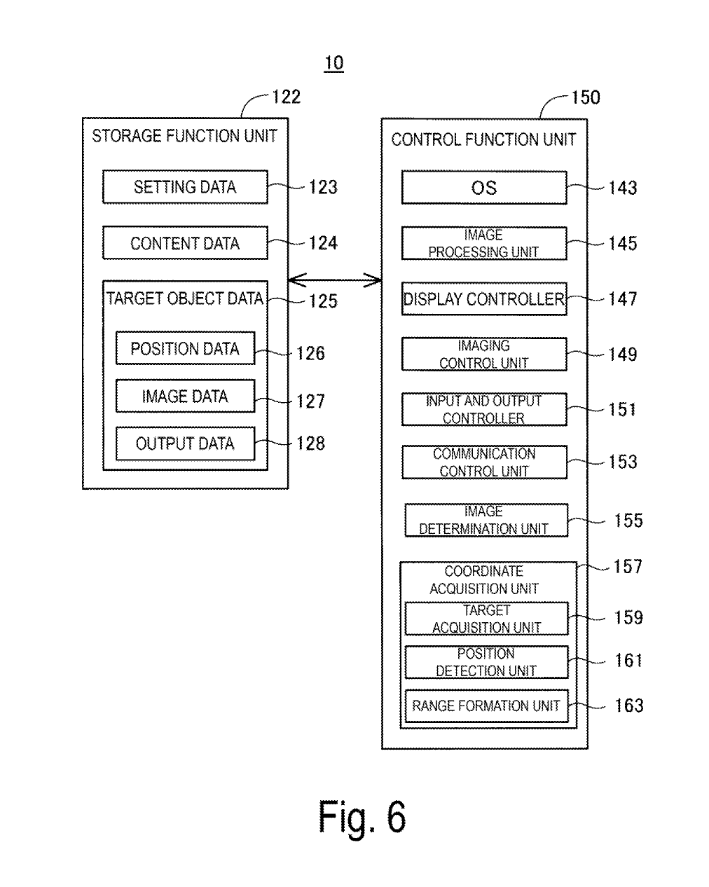

The imaging unit 61 according to the exemplary embodiment is a monocular camera. However, a stereo camera may be adopted. The imaging unit 61 is configured to capture an image of at least part of an external scene (real space) in a front direction of the HMD 100, in other words, in a direction of the field of view of the user when the user wears the image display unit 20. In other words, the imaging unit 61 is configured to capture an image in a range or direction overlapping the field of view of the user or an image in the direction of a scene visually recognized by the user. An angle of view of the imaging unit 61 can be appropriately set. In the exemplary embodiment, the angle of view of the imaging unit 61 is set to allow the imaging unit 61 to capture the entire field of view that is visually recognizable to the user through the right light-guiding plate 26 and the left light-guiding plate 28. The imaging unit 61 is controlled by a control function unit 150 (FIG. 5) to capture an image and output the data of the captured image to the control function unit 150 described below.

The HMD 100 may include a laser range scanner configured to detect a distance to an object located along a predetermined measurement direction. The laser range scanner is capable of acquiring three-dimensional spacial data by two-axis scanning. The laser range scanner may be arranged at the connection between the right light-guiding plate 26 and the left light-guiding plate 28 of the front frame 27, for example. The measurement direction of the laser range scanner may be the front direction of the HMD 100 (a direction overlapping an imaging direction of the imaging unit 61). The laser range scanner may include, for example, a light emitting part, such as an LED or a laser diode, and a light receiving part configured to receive light, which is emitted from the light source and reflected by the object to be measured. In this case, a distance is determined by triangulation processing or distance measurement processing based on a time difference. The laser range scanner may include, for example, a transmission part configured to transmit ultrasonic waves and a reception part configured to receive the ultrasonic waves reflected by an object to be measured. In this case, a distance is determined by the distance measurement processing based on the time difference. Like the imaging unit 61, the laser range scanner is controlled by the control function unit 150 and outputs the result of detection to the control function unit 150.

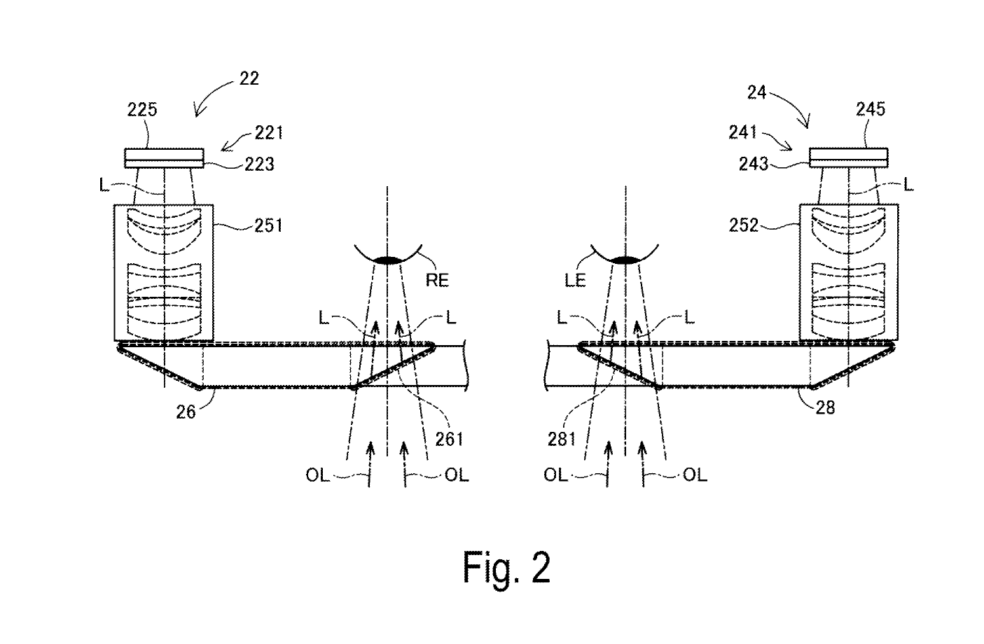

FIG. 2 is a plan view illustrating a main part of a configuration of an optical system included in the image display unit 20. For convenience of description, FIG. 2 schematically illustrates the right eye RE and the left eye LE of the user. As illustrated in FIG. 2, the right display unit 22 and the left display unit 24 are arranged symmetrically on the right- and left-hand sides.

To allow the right eye RE to view an image (AR image), the right display unit 22 includes an organic light emitting diode (OLED) unit 221 and a right optical system 251. The OLED unit 221 is configured to emit imaging light. The right optical unit 251 includes a lens group and the like and is configured to guide, to the right light-guiding plate 26, imaging light L emitted by the OLED unit 221.

The OLED unit 221 includes an OLED panel 223 and an OLED drive circuit 225 configured to drive the OLED panel 223. The OLED panel 223 is a light emission type display panel including light-emitting elements configured to emit red (R) color light, green (G) color light, and blue (B) color light, respectively, by organic electro-luminescence. The OLED panel 223 includes a plurality of pixels arranged in a matrix, each of the plurality of pixels including one element of R, one element of G, and one element of B.

The OLED drive circuit 225 is controlled by the control function unit 150, which will be described later, to select and power the light-emitting elements included in the OLED panel 223 to cause the light-emitting elements to emit light. The OLED drive circuit 225 is secured by bonding or the like, for example, onto a rear face of the OLED panel 223, i.e., back of a light-emitting surface. The OLED drive circuit 225 may include, for example, a semiconductor device configured to drive the OLED panel 223, and may be mounted onto a substrate secured to the rear face of the OLED panel 223. A temperature sensor 217 described later is mounted on the substrate. The OLED panel 223 may be configured to include light-emitting elements, arranged in a matrix, that emit white color light, and color filters, disposed over the light-emitting elements, that correspond to the R color, the G color, and the B color, respectively. The OLED panel 223 may have a WRGB configuration including light-emitting elements configured to emit white (W) color light, in addition to light-emitting elements configured to emit R color light, G color light, and B color light, respectively.

The right optical system 251 includes a collimate lens configured to collimate the imaging light L emitted from the OLED panel 223. The imaging light L collimated by the collimate lens enters the right light-guiding plate 26. In an optical path configured to guide light inside the right light-guiding plate 26, a plurality of reflective faces configured to reflect the imaging light L is formed. The imaging light L is reflected multiple times inside the right light-guiding plate 26 and then, is guided to the right eye RE side. In the right light-guiding plate 26, a half mirror 261 (reflective face) located in front of the right eye RE is formed. The image light L reflected by the half mirror 261 is emitted from the right light-guiding plate 26 to the right eye RE. The image light L forms an image on the retina of the right eye RE to allow the user to view the image.

To allow the left eye LE to view an image (AR image), the left display unit 24 includes an OLED unit 241 and a left optical system 252. The OLED unit 241 is configured to emit imaging light. The left optical system 252 includes a lens group and the like, and is configured to guide, to the left light-guiding plate 28, imaging light L emitted by the OLED unit 241. The OLED unit 241 includes an OLED panel 243 and an OLED drive circuit 245 configured to drive the OLED panel 243. For further details, the OLED unit 241, the OLED panel 243, and the OLED drive circuit 245 are the same as the OLED unit 221, the OLED panel 223, and the OLED drive circuit 225, respectively. A temperature sensor 239 is mounted on a substrate secured to a rear surface of the OLED panel 243. For further details, the left optical system 252 is the same as the right optical system 251.

According to the configuration described above, the HMD 100 may serve as a transmission type (see-through type) display apparatus. That is, the imaging light L reflected by the half mirror 261 and the outside light OL passing through the right light-guiding plate 26 enter the right eye RE of the user. The imaging light L reflected by the half mirror 281 and the outside light OL passing through the left light-guiding plate 28 enter the left eye LE of the user. In this manner, the HMD 100 allows the imaging light L of the internally processed image and the outside light OL to enter the eyes of the user in an overlapped manner. As a result, the user visually recognizes an external scene (real world) through the right light-guiding plate 26 and the left light-guiding plate 28, and also visually recognizes an image (AR image) formed by the imaging light L overlapping the external scene.

Note that, the half mirror 261 and the half mirror 281 are configured to function as image extraction units configured to extract an image by reflecting imaging light output by the right display unit 22 and the left display unit 24. Further, the right optical system 251 and the right light-guiding plate 26 are also collectively referred to as a “right light-guiding unit”, and the left optical system 252 and the left light-guiding plate 28 are also collectively referred to as a “left light-guiding unit”. Configurations of the right light-guiding unit and the left light-guiding unit are not limited to the example described above, and any desired configuration may be adopted as long as imaging light forms an image in front of the eyes of the user. For example, diffraction gratings or translucent reflective films may be used for the right light-guiding unit and the left light-guiding unit.

In FIG. 1, the controller 10 and the image display unit 20 are connected together via a connection cable 40. The connection cable 40 is removably connected to a connector provided in a lower portion of the controller 10 and connects to various circuits inside the image display unit 20 through a tip AL of the left holding part 23. The connection cable 40 includes a metal cable or an optical fiber cable through which digital data is transmitted. The connection cable 40 may further include a metal cable through which analog data is transmitted. A connector 46 is provided in the middle of the connection cable 40.

The connector 46 is a jack to which a stereo mini-plug is connected, and is connected to the controller 10, for example, via a line through which analog voice signals are transmitted. In the example of the exemplary embodiment illustrated in FIG. 1, the connector 46 connects to a right earphone 32 and a left earphone 34 constituting a stereo headphone and to a headset 30 including a microphone 63.

As illustrated in FIG. 1, for example, the microphone 63 is arranged such that a sound collector of the microphone 63 faces in a sight direction of the user. The microphone 63 is configured to collect voice and output voice signals to a voice interface 182 described later. The microphone 63 may be a monaural microphone or a stereo microphone, or may be a directional microphone or a non-directional microphone.

The controller 10 is a device configured to control the HMD 100. The controller 10 includes an illumination part 12, a touch pad 14, a direction key 16, an enter key 17, and a power switch 18. The illumination part 12 is configured to inform the user of an operation-state of the HMD 100 (e.g., power ON/OFF) with its light-emitting mode. The illumination part 12 may be, for example, light-emitting diodes (LEDs).

The touch pad 14 is configured to detect a touch operation on an operation surface of the touch pad 14 to output a signal corresponding to what is detected. Any of various touch pads, such as an electrostatic-type touch pad, a pressure detection-type touch pad, or an optical touch pad may be adopted as the touch pad 14. The direction key 16 is configured to detect a push operation onto any of keys corresponding to up, down, right and left directions to output a signal corresponding to what is detected. The enter key 17 is configured to detect a push operation to output a signal used to determine the operation performed on the controller 10. The power switch 18 is configured to detect a switch sliding operation to switch the state of the power supply for the HMD 100.

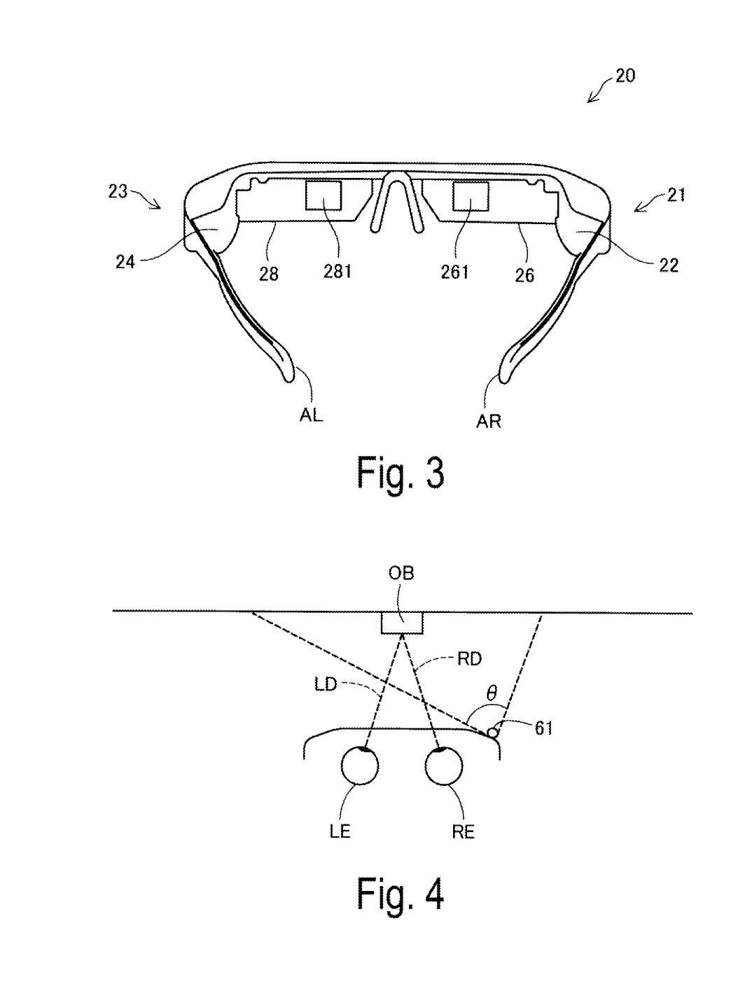

FIG. 3 is a diagram illustrating a configuration of a main part of the image display unit 20 as viewed from the user. In FIG. 3, illustration of the connection cable 40, the right earphone 32, and the left earphone 34 is omitted. In the state illustrated in FIG. 3, back sides of the right light-guiding plate 26 and the left light-guiding plate 28 are visible. The half mirror 261 configured to radiate imaging light to the right eye RE, and the half mirror 281 configured to radiate imaging light to the left eye LE are also visible as approximately square-shaped regions. The user visually recognizes an external scene through the entire areas of the right light-guiding plate 26 and the left light-guiding plate 28 including the half mirrors 261 and 281, and also visually recognizes rectangular displayed images at the positions of the half mirrors 261 and 281.

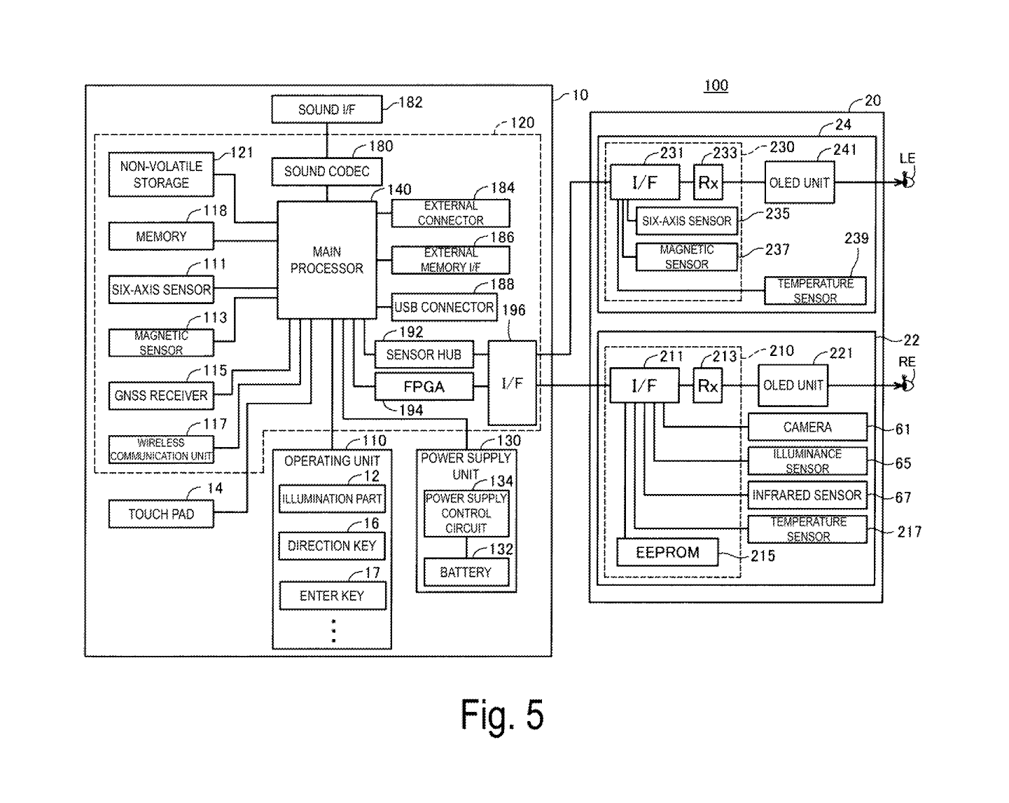

FIG. 4 is a diagram illustrating an angle of view of the imaging unit 61. FIG. 4 schematically illustrates the imaging unit 61, along with the right eye RE and the left eye LE of the user, in a plan view. The angle of view (imaging range) of the imaging unit 61 is represented by θ. Note that, the angle of view θ of the imaging unit 61 extends not only in a horizontal direction as illustrated in the figure, but also in a perpendicular direction as is the case with any common digital camera.

As described above, the imaging unit 61 is arranged at an end of on the right-hand side of the image display unit 20 to capture an image in the sight direction of the user (i.e., in front of the user). Thus, the optical axis of the imaging unit 61 extends in a direction including sight directions of the right eye RE and the left eye LE. The external scene that can be recognized visually by the user when the user wears the HMD 100 is not necessarily an infinitely distant scene. For example, in a case where the user fixates on an object OB with both eyes, the line-of-sight of the user is directed to the object OB like line-of-sight RD and line-of-sight LD illustrated with reference signs in the figure. In this case, the distance from the user to the object OB often ranges from approximately 30 cm to 10 m, both inclusive, and more often ranges from 1 m to 4 m, both inclusive. Thus, standard maximum and minimum distances from the user to the object OB that the user can take during normal use of HMD 100 may be specified. These standards may be predetermined and preset in the HMD 100 or they may be set by the user. The optical axis and the angle of view of the imaging unit 61 are preferably set such that the object OB is included within the angle of view in a case where the distance to the object OB during normal use corresponds to the set standards of the maximum and minimum distances.

In general, the viewing angle of a human is known to be approximately 200 degrees in the horizontal direction and approximately 125 degrees in the vertical direction. Within these angles, an effective visual field advantageous for information acceptance performance is approximately 30 degrees in the horizontal direction and approximately 20 degrees in the vertical direction. In general, a stable field of fixation in which a human can promptly and stably view any point of fixation ranges from approximately 60 degrees to 90 degrees, both inclusive, in the horizontal direction and from approximately 45 degrees to 70 degrees, both inclusive, in the vertical direction. In this case, when the point of fixation is located at the object OB, the effective field of view is approximately 30 degrees in the horizontal direction and approximately 20 degrees in the vertical direction with the lines of sight RD and LD as the center. Furthermore, the stable visual field of fixation ranges from approximately 60 degrees to 90 degrees, both inclusive, in the horizontal direction and from approximately 45 degrees to 70 degrees, both inclusive, in the vertical direction. The visual field of the user actually viewing an object through the image display unit 20, the right light-guiding plate 26, and the left light-guiding plate 28 is referred to as an actual field of view (FOV). The actual field of view is narrower than the visual field angle and the stable field of fixation, but is wider than the effective visual field.

The angle of view θ of the imaging unit 61 according to the exemplary embodiment is set to capture a range wider than the visual field of the user. The angle of view θ of the imaging unit 61 is preferably set to capture a range wider than at least the effective visual field of the user and is more preferably set to capture a range wider than the actual field of view. The angle of view θ of the imaging unit 61 is even more preferably set to capture a range wider than the stable field of fixation of the user, and is most preferably set to capture a range wider than the visual field angle of the eyes of the user. The imaging unit 61 may thus include a wide angle lens as an imaging lens, and may be configured to capture an image with a wider angle of view. The wide angle lens may include a super-wide angle lens or a semi-wide angle lens. Further, the imaging unit 61 may also include a fixed focal lens, a zoom lens, or a lens group including a plurality of lenses.

FIG. 5 is a functional block diagram illustrating a configuration of the HMD 100. The controller 10 includes a main processor 140 configured to execute a program to control the HMD 100, storage units, input and output units, sensors, interfaces, and a power supply unit 130. The main processor 140 connects to the storage units, the input/output units, the sensors, the interfaces, and the power supply unit 130. The main processor 140 is mounted on a controller substrate 120 built into the controller 10.

The storages include a memory 118 and a nonvolatile storage 121. The memory 118 constitutes a work area in which computer programs and data to be processed by the main processor 140 are temporarily stored. The non-volatile storage unit 121 includes a flash memory and an embedded multi-media card (eMMC). The nonvolatile storage unit 121 is configured to store computer programs to be executed by the main processor 140 and various data to be processed by the main processor 140. In the exemplary embodiment, these storage units are mounted on the controller substrate 120.

The input and output units include the touch pad 14 and an operation unit 110. The operation unit 110 includes the direction key 16, the enter key 17, and the power switch 18, which are included in the controller 10. The main processor 140 is configured to control the input and output units and acquire signals output from the input and output units.

The sensors include a six-axis sensor 111, a magnetic sensor 113, and a global navigation satellite system (GNSS) receiver 115. The six-axis sensor 111 is a motion sensor (inertia sensor) including a three-axis acceleration sensor and a three-axis gyro (angular velocity) sensor. An inertial measurement unit (IMU) in which these sensors are provided as modules may be adopted as the six-axis sensor 111. The magnetic sensor 113 is a three-axis geomagnetic sensor, for example. The GNSS receiver 115 includes a GNSS receiving set (not illustrated), and receives a radio signal transmitted from a satellite to detect coordinates of a current location of the controller 10. The sensors (six-axis sensor 111, magnetic sensor 113, and GNSS receiver 115) output detected values to the main processor 140 in accordance with a predetermined sampling frequency. The sensors may output detected values at timings instructed by the main processor 140.

The interfaces include a wireless communication unit 117, a voice codec 180, an external connector 184, an external memory interface 186, a universal serial bus (USB) connector 188, a sensor hub 192, an FPGA 194, and an interface 196. The components are configured to function as an interface with external devices.

The wireless communication unit 117 is configured to perform wireless communication between the HMD 100 and an external device. The wireless communication unit 117 is configured to include an antenna (not illustrated), a radio frequency (RF) circuit, a baseband circuit, a communication control circuit, and the like, or is configured as a device into which these components are integrated. The wireless communication unit 117 is configured to perform wireless communication in compliance with standards such as Bluetooth (trade name) and wireless LAN including Wi-Fi (trade name).

The voice codec 180 is connected to the voice interface 182, and is configured to encode and decode voice signals input and output via the voice interface 182. The voice interface 182 is an interface configured to input and output the voice signals. The voice codec 180 may include an A/D converter configured to convert an analog voice signal into digital voice data and a digital/analog (D/A) converter configured to convert digital voice data into an analog voice signal. The HMD 100 according to the exemplary embodiment outputs voice from the right earphone 32 and the left earphone 34 and collects voice from the microphone 63. The voice codec 180 is configured to convert digital voice data output by the main processor 140 into an analog voice signal, and output the analog voice signal via the voice interface 182. Further, the voice codec 180 converts an analog sound signal input into the voice interface 182 into digital sound data, and outputs the digital voice data to the main processor 140.

The external connector 184 is a connector configured to connect the main processor 140 to an external device (e.g., personal computer, smartphone, or gaming device) configured to communicate with the main processor 140. The external device connected to the external connector 184 may serve as a source of content, may debug a computer program to be executed by the main processor 140, and may collect an operation log of the HMD 100. The external connector 184 may take various forms. The external connector 184 may be a wired-connection interface such as a USB interface, a micro USB interface, and memory card interface, or a wireless-connection interface such as a wireless LAN interface and a Bluetooth interface.

The external memory interface 186 is an interface configured to connect a portable memory device. The external memory interface 186 includes, for example, a memory card slot configured to accept a card recording medium for reading and writing data, and an interface circuit. The size, shape, standards, and the like of the card recording medium may be appropriately selected. The USB connector 188 is an interface configured to connect a memory device, a smartphone, a personal computer, or the like in compliance with the USB standard.

The USB connector 188 includes, for example, a connector in compliance with the USB standard and an interface circuit. For example, the size and shape of the USB connector 188, as well as the version of USB standard to be used for the USB connector 188, may be appropriately selected.

The sensor hub 192 and the FPGA 194 are connected to the image display unit 20 via the interface (I/F) 196. The sensor hub 192 is configured to acquire detected values of the sensors included in the image display unit 20 and output the detected values to the main processor 140. The FPGA 194 is configured to process data to be transmitted and received between the main processor 140 and components of the image display unit 20, and perform transmissions via the interface 196. The interface 196 is connected to the right display unit 22 and the left display unit 24 of the image display unit 20. In the example of the exemplary embodiment, the connection cable 40 is connected to the left holding part 23. Wiring, in the image display unit 20, connected to the connection cable 40 causes the right display unit 22 and the left display unit 24 to be connected to the interface 196 of the controller 10.

The power supply unit 130 includes a battery 132 and a power supply control circuit 134. The power supply unit 130 is configured to supply power used to operate the controller 10. The battery 132 is a rechargeable battery. The power supply control circuit 134 is configured to detect a remaining capacity of the battery 132 and control charging of an OS 143 described later. The power supply control circuit 134 is connected to the main processor 140, and is configured to output the detected value of the remaining capacity of the battery 132 and the detected value of a voltage of the battery 132 to the main processor 140. Note that, power may be supplied from the controller 10 to the image display unit 20, based on the power supplied by the power supply unit 130. The main processor 140 may be configured to control the state of power supply from the power supply unit 130 to components of the controller 10 and the image display unit 20.

The right display unit 22 includes a display unit substrate 210, an OLED unit 221, the imaging unit 61, an illuminance sensor 65, an infrared sensor 67, and a temperature sensor 217. The display unit substrate 210 is equipped with an interface (I/F) 211 connected to the interface 196, a receiving unit (Rx) 213, and an electrically erasable programmable read-only memory (EEPROM) 215. The receiving unit 213 is configured to receive data from the controller 10 via the interface 211. In a case of receiving image data of an image to be displayed on the OLED unit 221, the receiving unit 213 outputs the received image data to the OLED drive circuit 225 (FIG. 2).

The EEPROM 215 is configured to store various data in such a manner that the main processor 140 can read the data. The EEPROM 215 is configured to store, for example, data about light emission properties and display properties of the OLED units 221 and 241 of the image display unit 20, and data about sensor properties of the right display unit 22 or the left display unit 24. Specifically, for example, the EEPROM 215 is configured to store parameters regarding Gamma correction performed by the OLED units 221 and 241, and data used to compensate for the detected values of the temperature sensors 217 and 239 described later. These kinds of data are generated by inspection at the time of shipping of the HMD 100 from a factory, and are written into the EEPROM 215. After shipment, the data is loaded from the EEPROM 215 into the main processor 140, and is used for various processes.

The imaging unit 61 is configured to capture an image in accordance with a signal input via the interface 211, and output image data or a signal indicating the result of imaging to the controller 10. As illustrated in FIG. 1, the illuminance sensor 65 is arranged on the end ER of the front frame 27 and is configured to receive outside light from the front of the user wearing the image display unit 20. The illuminance sensor 65 is configured to output a detected value corresponding to the amount of received light (intensity of received light).

As illustrated in FIG. 1, the infrared sensor 67 is arranged near the imaging unit 61 at the end ER of the front frame 27. The infrared sensor 67 is configured to receive an infrared light beam, which is emitted from a target instruction device 300 described later and reflected by an object. The infrared sensor 67 includes a position sensitive detector (PSD).

The temperature sensor 217 is configured to detect a temperature to output a voltage value or a resistance value corresponding to the detected temperature. The temperature sensor 217 is mounted on the rear face side of the OLED panel 223 (FIG. 3). The temperature sensor 217 may be mounted, for example, on the same substrate as the substrate on which the OLED drive circuit 225 is mounted. This configuration allows the temperature sensor 217 to mainly detect the temperature of the OLED panel 223. Note that, the temperature sensor 217 may be built into the OLED panel 223 or the OLED drive circuit 225. For example, in a case where the OLED panel 223, together with the OLED drive circuit 225, is mounted as an Si-OLED on an integrated semiconductor chip to form an integrated circuit, the temperature sensor 217 may be mounted on the semiconductor chip.

The left display unit 24 includes a display unit substrate 230, an OLED unit 241, and a temperature sensor 239. The display unit substrate 230 is equipped with an interface (I/F) 231 connected to the interface 196, a receiving unit (Rx) 233, a six-axis sensor 235, and a magnetic sensor 237. The receiving unit 233 is configured to receive data input from the controller 10 via the interface 231. In a case where the receiving unit 233 receives image data of an image to be displayed on the OLED unit 241, the receiving unit 233 outputs the received image data to the OLED drive circuit 245 (FIG. 2).

The six-axis sensor 235 is a motion sensor (inertial sensor) including a three-axis acceleration sensor and a three-axis gyro (angular velocity) sensor. The six-axis sensor 235 may be an IMU in which the above-described sensors are provided as modules. The magnetic sensor 237 is a three-axis geomagnetic sensor, for example. The six-axis sensor 235 and the magnetic sensor 237 are provided in the image display unit 20, and thus detecting a motion of the head of the user when the image display unit 20 is mounted on the user's head. The orientation of the image display unit 20, i.e., the field of view of the user, is determined based on the detected motion of the head.

The temperature sensor 239 is configured to detect the temperature to output a voltage value or a resistance value corresponding to the detected temperature. The temperature sensor 239 is mounted on the rear face side of the OLED panel 243 (FIG. 3). The temperature sensor 239 may be mounted, for example, on the same substrate as the substrate on which the OLED drive circuit 245 is mounted. This configuration allows the temperature sensor 239 to mainly detect the temperature of the OLED panel 243. The temperature sensor 239 may be built into the OLED panel 243 or the OLED drive circuit 245. Details of the temperature sensor 239 are similar to the temperature sensor 217.

The sensor hub 192 of the controller 10 connects to the imaging unit 61, the illuminance sensor 65, the infrared sensor 67, and the temperature sensor 217 of the right display unit 22, and to the six-axis sensor 235, the magnetic sensor 237, and the temperature sensor 239 of the left display unit 24. The sensor hub 192 is configured to set and initialize a sampling period of each sensor under the control of the main processor 140. Based on the sampling periods of the sensors, the sensor hub 192 supplies power to the sensors, transmits control data, and acquires detected values, for example. The sensor hub 192 is configured to output, at a preset timing, detected values of the sensors included in the right display unit 22 and the left display unit 24, to the main processor 140. The sensor hub 192 may be configured to include a cache function to temporarily retain the detected values of the sensors. The sensor hub 192 may be configured to include a function to convert a signal format or a data format of detected values of the sensors (e.g., function for conversion into a standard format).

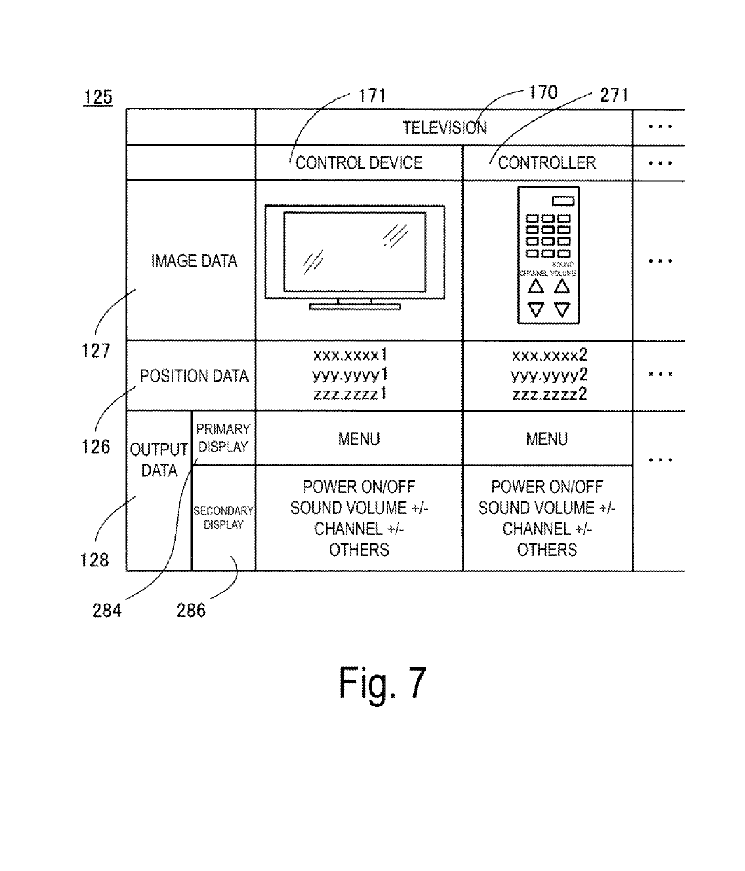

FIG. 6 is a functional block diagram illustrating a configuration of the controller 10. In terms of function units, the controller 10 includes a storage function unit 122 and a control function unit 150. The storage function unit 122 is a logical storage configured upon the nonvolatile storage 121 (FIG. 5). Instead of a configuration in which only the nonvolatile storage 121 is used, the storage function unit 122 may be configured to use the EEPROM 215 or the memory 118 in combination with the nonvolatile storage 121.

The storage function unit 122 is configured to store various data required to be processed by the control function unit 150. Specifically, the storage function unit 122 according to the exemplary embodiment stores setting data 123, content data 124, and target object data 125.

The setting data 123 includes various set values regarding operation of the HMD 100. For example, the setting data 123 includes parameters, determinants, computing equations, look-up tables (LUTs), and the like used when the control function unit 150 controls the HMD 100.

The content data 124 includes data of contents including images and movies (image data, movie data, sound data, and the like) to be displayed on the image display unit 20 controlled by the control function unit 150. The content data 124 may include data of bidirectional content. The term bidirectional content means a type of content that is displayed by the image display unit 20 in accordance with an operation of the user. The operating unit 110 acquires the operation of the user, the control function unit 150 performs processing corresponding to the acquired operation, and the image display unit 20 displays content corresponding to the processing. In this case, the data representing the content may include data such as image data of a menu screen used to acquire an operation of the user, and data for specifying processing corresponding to an item included on the menu screen.

The target object data 125 includes position data 126 being three-dimensional information acquired by the imaging unit 61 and the infrared sensor 67, image data 127 for an image determination unit 155 described later to perform image recognition processing, and output data 128 output as a virtual object described later.

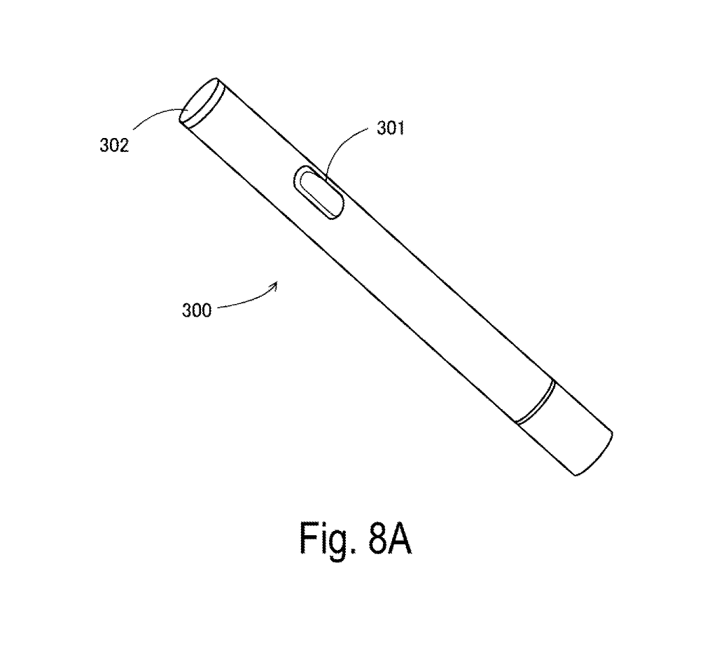

FIG. 7 is a schematic diagram illustrating a part of the target object data 125 stored in the storage unit of the storage function unit 122. In the example in FIG. 7, there are illustrated the respective items of the target object data 125 such as the image data 127, the position data 126, and the output data 128, and data corresponding to the respective target objects such as a control apparatus 170.

In the exemplary embodiment, the target object data 125 includes a plurality of data associated with the control apparatus 170 being a target to be controlled by the control function unit 150. For example, as for a television being one example of the control apparatus 170, the data of the two target objects, which are a control device 171 for displaying a screen and a controller 271 operating the control device 171, is stored. That is, in the target object data 125, each of the control device 171 and the controller 271 of the control apparatus 170 (television) is associated with the image data 127 and the position data 126, and the output data 128.

The position data 126 is data in which a relative position (coordinate) of each object included in an external scene (hereinafter, also referred to as a “target object”) with respect to the HMD 100 and a position range of the target object are stored. Herein, the term a “position range of a target object” refers to one region which the target object occupies in a three-dimensional space, and one region surrounded by a plurality of three-dimensional coordinates forming the target object. The image data 127 is three-dimensional image data of the object stored in the storage unit of the storage function unit 122 in advance.

The output data 128 is an image associated with the target object to be controlled by the controller 10, and an image displayed on the image display unit 20 by a display control unit 147 (hereinafter, also referred to as a “virtual object”). In the exemplary embodiment, the virtual object is formed of a text image and a frame image including a region corresponding to a size of a display region of the text image. The virtual object is further classified into a first display 284 and a second display 286, and is stored in the storage unit in advance.

In the exemplary embodiment, the virtual object is associated with control of each text image. For example, as for “menu” in the text image, control of displaying a menu screen is associated. As for “Power ON” in the text image, control for switching the power of the control device to an on state is associated. Note that, some virtual objects are not associated with any control. For example, in a case where the text image is a name of the target object, when the user specifies the target object, the controller 10 only performs control for displaying the name of the target object on the displayed virtual object. With this control, the user can specify the target object more reliably.

In the exemplary embodiment, in addition to the data associated with the above-mentioned control apparatus 170, data indicating change of the position of the object stored in advance is included in the target object data 125. Specifically, the target object data 125 includes an image of an object (not illustrated) and a plurality of images being data indicating change of positions of the image of the object, in which the object is continuously moving in one screen. The data indicating change of positions of the image of the object may include information indicating change of coordinates with coordinates after the move compared to coordinates before the change recorded in advance. With this, the image determination unit 155 described later performs pattern matching being image recognition processing on an object moved by the user to detect a gesture of the user. In the exemplary embodiment, a finger of the user is included in the image of the object, the data indicating change of positions of the image of the object includes data of a horizontal direction in which the finger of the user moves.

Referring back to FIG. 6, the control function unit 150 is configured upon the main processor 140 that executes a computer program, i.e., upon hardware and software that operate together. More specifically, the control function unit 150 is configured to utilize the data stored in the storage function unit 122 to execute various processes, thereby performing functions as the OS 143, an image processing unit 145, the display control unit 147, an imaging control unit 149, an input and output control unit 151, a communication control unit 153, the image determination unit 155, and a coordinate acquisition unit 157. In the exemplary embodiment, the function units other than the OS 143 are configured as computer programs to be executed on the OS 143.

The image processing unit 145 is configured to generate, based on image data or video data to be displayed on the image display unit 20, signals to be transmitted to the right display unit 22 and the left display unit 24. The signals generated by the image processing unit 145 may be a vertical synchronization signal, a horizontal synchronization signal, a clock signal, an analog image signal, and the like. The image processing unit 145 may be implemented by the main processor 140 that executes a corresponding computer program, or may be configured by using hardware different from the main processor 140 (e.g., a digital signal processor (DSP)).

The image processing unit 145 may be configured to execute resolution conversion processing, image adjustment processing, a 2D/3D conversion process, and the like as needed. The resolution conversion processing is processing for converting the resolution of image data into a resolution appropriate for the right display unit 22 and the left display unit 24. The image adjustment processing is processing for adjusting the brightness and saturation of image data. The 2D/3D conversion processing is processing for generating two-dimensional image data from three-dimensional image data, or generating three-dimensional image data from two-dimensional image data. In a case where any of the processing operations is executed, the image processing unit 145 is configured to generate a signal for displaying an image based on the processed image data and transmits the signal to the image display unit 20 via the connection cable 40.

The display controller 147 is configured to generate enable signals for controlling the right display unit 22 and the left display unit 24, and use the enable signals to control the generation and emission of the image light by each of the right display unit 22 and the left display unit 24. Specifically, the display controller 147 is configured to control the OLED drive circuits 225 and 245 to cause the OLED panels 223 and 243 to display images. The display controller 147 is configured to control, for example, a timing when the OLED drive circuits 225 and 245 draw images on the OLED panels 223 and 243, and brightness of the OLED panels 223 and 243, based on the signal output by the image processing unit 145.

The imaging control unit 149 is configured to control the imaging unit 61 to capture an image and generate captured image data, and to cause the storage function unit 122 to temporarily store the captured image data. Further, in a case where the imaging unit 61 is configured as a camera unit including a circuit for generating captured image data, the imaging control unit 149 is configured to acquire the captured image data from the imaging unit 61 and temporarily store the image data to the target object data 125 in the storage function unit 122.

The input and output control unit 151 is configured to appropriately control the touch pad 14 (FIG. 1), the direction key 16, and the enter key 17 to acquire input commands. The acquired instructions are output to the OS 143 or to a computer program to be executed on the OS 143 together with the OS 143. The communication control unit 153 controls the wireless communication unit 117 to perform wireless communication between the HMD 100 and external devices such as a navigation device.

The image determination unit 155 performs image analysis on the image captured by the imaging unit 61 and image analysis on the image generated by the display control unit 147. In the exemplary embodiment, the image determination unit 155 performs, on the image of the target object captured by the imaging unit 61, pattern matching being image recognition processing for making comparison with the image data 127 included in the target object data 125. With this, the image determination unit 155 performs image determination processing for determining whether the image data 127 being an image stored in advance matches the target object.

Herein, the target object determined to match the image data 127 by the image determination unit 155 is also referred to as a “specific target”. In the exemplary embodiment, the virtual object is included in the specific object. The image determination unit 155 performs pattern matching on the target object moved by the user in each of frames of the images sequentially captured by the imaging unit 61. In this manner, the gesture of the user (confirmation operation described later) is detected.

The coordinate acquisition unit 157 includes a target acquisition unit 159, a position detection unit 161, and a range formation unit 163. The coordinate acquisition unit 157 is configured to perform processing for determining the target object, which is specified by the user from the target objects included in the external scene, as the target object to be controlled. Herein, an action of the user to designate the target object to be controlled is also referred to as “to specify”, and the specific target designated by the user is also referred to as a “specific object”.

The target acquisition unit 159 is configured to acquire a position range of one or more target objects included in the external scene. In the exemplary embodiment, the target acquisition unit 159 performs processing simultaneously performing processing for analyzing the images continuously captured by the imaging unit 61 and estimating the position and the orientation of the imaging unit 61, that is, so-called self position estimation processing, and processing for estimating and forming three-dimensional information (a map) of the external scene (hereinafter, also referred to as “simultaneous localization and mapping (SLAM)”. With this, for each target object included in the external scene, the target acquisition unit 159 acquires relative coordinates and a distance between the imaging unit 61 (that is, the image display unit 20 of the HMD 100) and the target object, and acquires information on the position range of the target object. The acquired information on the position range of the target object is stored in the position data 126, and is successively updated at each time of acquisition.

The position detection unit 161 calculates a direction of a center axis of the target instruction device 300 described later based on a result of acceleration received from the target instruction device 300. In the exemplary embodiment, by utilizing the principle of triangulation, the position detection unit 161 further calculates a distance between the HMD 100 and target object based on position information of reflected infrared ray laser, which is received by the PSD of the infrared sensor 67.

The range formation unit 163 provides the virtual object, which is displayed on the image display unit 20, with a position range corresponding to a size of the frame image of the virtual object. With this, the user can indicate the virtual object displayed on the image display unit 20 with the target instruction device 300 so as to specify the virtual object. In this manner, the image corresponding to the virtual object can be displayed on the image display unit 20. Therefore, the user specifies the virtual object to be controlled at his or her own will, and the image corresponding to the virtual object can be displayed on the image display unit 20.

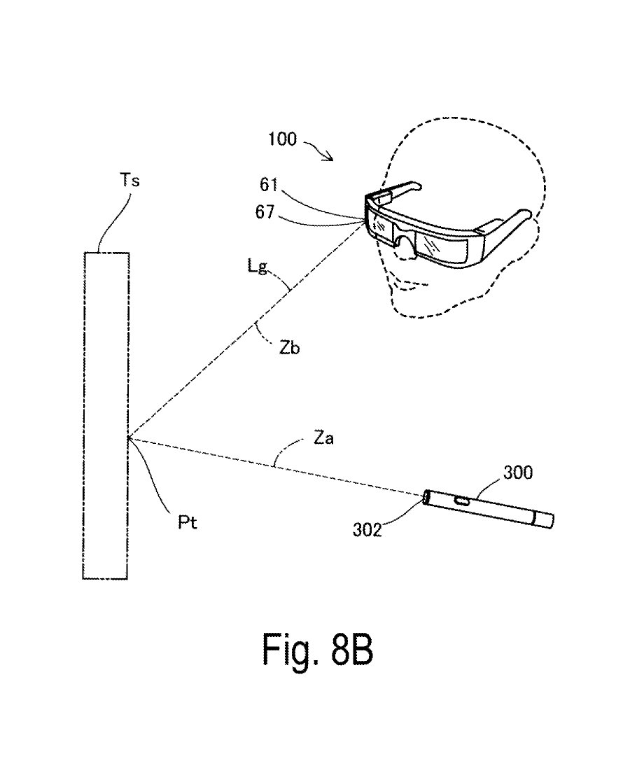

FIG. 8A is a perspective diagram illustrating the target instruction device 300 to be used by the user in the exemplary embodiment. The target instruction device 300 is a substantially columnar-shaped device, and is used in order to specify the target object included in the external scene in the exemplary embodiment. The target instruction device 300 includes an output unit 302 and a switch 301. The output unit 302 includes an infrared LED light source. The switch 301 is used for activating and stopping the target instruction device 300 and emitting an infrared laser at the time of activation.

The activated target instruction device 300 emits an infrared laser in a direction along the center axis of the target instruction device 300 from a distal end of the output unit 302 when the switch 301 is pressed. The infrared laser emitted from the target instruction device 300 to the target object is reflected by the target object, and is detected by the infrared sensor 67 of the right display unit 22.

In the exemplary embodiment, the target instruction device 300 further includes a three-axis acceleration sensor (not illustrated) thereinside, which is formed of micro electro mechanical systems (MEMSs). The result of acceleration in three-axis directions detected by the acceleration sensor is successively transmitted to the position detection unit 161 of the control function unit 150. The transmission of the detection result of the acceleration by the acceleration sensor may be performed only during a time period while the switch 301 is pressed.

The coordinate acquisition unit 157 (see FIG. 6) calculates one direction in which the user points through the target instruction device 300 based on the detection result of the direction of the center axis of the target instruction device 300, which is acquired by the position detection unit 161. The coordinate acquisition unit 157 calculates a linear line along the one direction determined in accordance with the instruction by the user through the target instruction device 300, and a cross point at a position closest to the user side (the HMD 100 side) among the cross points in the position range of the target object acquired by the above-mentioned SLAM processing (hereinafter, also referred to as a “target cross point”). In the exemplary embodiment, the target cross point is a cross point of the linear line indicated by the user and the target object. However, the target cross point is not limited to a point. A common portion of the direction indicated by the user and the position range of the target object may include a preset range having, for example, a surface shape or a three-dimensional shape. Herein, the common portion of the direction indicated by the user and the position range of the target object is also referred to as an “instruction region”. That is, the coordinate acquisition unit 157 is only required to acquire the instruction region at a position closest to the user side in the instruction region.

In the exemplary embodiment, further, the coordinate acquisition unit 157 utilizes the calculation result of the distance to the target object, which is detected by the infrared sensor 67 with the infrared laser, compares the calculation result and the distance to the above-mentioned cross point, and corrects the position of the cross point at the position closest to the user side.

FIG. 8B is a schematic explanatory diagram illustrating correction of the position of the cross point by the coordinate acquisition unit 157. In FIG. 8B, there is illustrated a state in which the user wearing the HMD 100 specifies the target cross point on a television Ts, which is one of the specific targets of target objects OB, at a position Pt through the target instruction device 300. The two-dot chain line in FIG. 8B schematically indicates a position range of the television Ts. The position detection unit 161 calculates the direction of the center axis of the target instruction device 300 based on the result of acceleration received from the target instruction device 300. The coordinate acquisition unit 157 acquires a distance Lg between the HMD 100 and the position Pt of the target cross point of the television Ts.

The user operates the target instruction device 300 to emit the infrared laser. Accordingly, the infrared laser Za is emitted from the output unit 302. The infrared laser Za is reflected at the position Pt of the television Ts to turn into reflected light Zb, and is received by the infrared sensor 67. The coordinate acquisition unit 157 calculates the distance Lg between the HMD 100 and the position Pt of the television Ts by utilizing coordinates of the position Pt recognized by the coordinate acquisition unit 157 and change of a receiving position of the reflected light Zb, which is acquired by the PSD of the infrared sensor 67. The controller 10 may acquire the coordinates of the target instruction device 300, and the emitting position of the infrared laser Za may be used for calculation. In the exemplary embodiment, for example, in a case where the distance Lg being an actual measured value through use of the infrared laser and the distance Lg acquired with SLAM processing by the coordinate acquisition unit 157 are different from each other, the coordinate acquisition unit 157 corrects the distance Lg acquired with SLAM processing to the actual measured value by emphasizing more on the actual measured value through use of the infrared laser. Note that, this correction may not be performed. The coordinate acquisition unit 157 is only required to acquire the instruction region at a position closest to the user side among the instruction regions.

As described above, the user can specify the target object at a position closest to the user side, which includes the cross point in the position range. With this, the controller 10 is capable of displaying the image corresponding to the target object with the cross point included in the position range, which is closest to the user side on the indicated linear line in response to the instruction of the user. Therefore, the user specifies the target object to be controlled at his or her own will, and the image corresponding to the target object can be displayed on the image display unit.

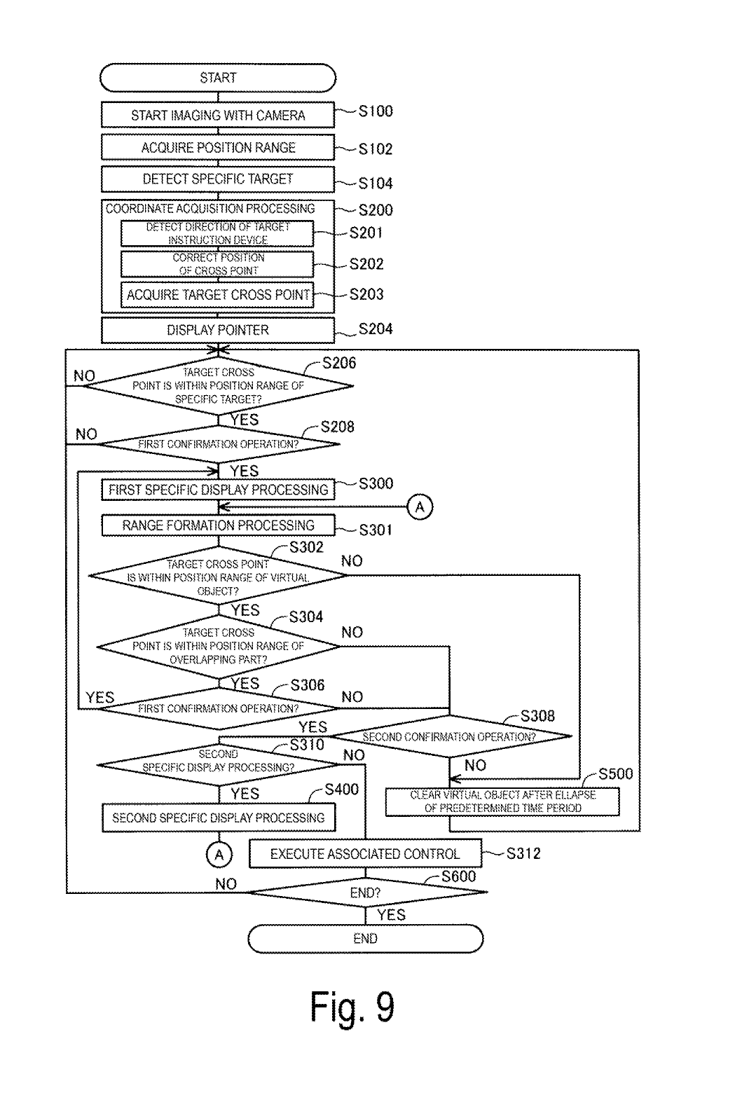

FIG. 9 is a flowchart of the control performed by the controller 10 in the exemplary embodiment. For example, when the user turns the power switch 18 of the HMD 100 into an on state, the controller 10 is activated together with the respective modules including the imaging unit 61, and starts control. Now, with reference to FIG. 9 and other figures, description is made of control flow performed by the controller 10.

In step S100, when the controller 10 has been activated, the imaging control unit 149 controls the imaging unit 61 (see FIG. 1) to start imaging an external scene SC. In step S102, along with imaging of the external scene SC by the imaging unit 61, the target acquisition unit 159 performs SLAM processing to start processing for estimating the position and orientation of the imaging unit 61 and three-dimensional information on the external scene SC. In this manner, the position range of the target object is acquired.

In step S104, the image determination unit 155 performs pattern matching to compare the image data 127 of the target object data 125 and the target object captured by the imaging unit 61, and determines the target object matching the image data 127 as the specific target.

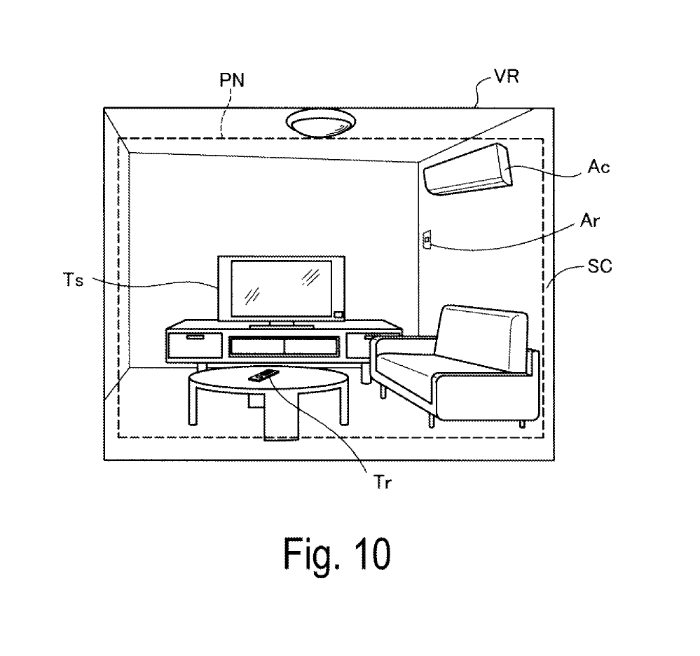

FIG. 10 is an explanatory diagram illustrating an example of a visual field VR that the user wearing the HMD 100 visually recognizes through the image display unit 20. In FIG. 10, there are illustrated the external scene SC visually recognized by the user in a living room and a maximum region PN of an image displayed by the display control unit 147. In FIG. 10, the maximum region PN includes the television Ts, a television remote controller Tr, an air-conditioner Ac, and an air-conditioner operation panel Ar. Note that, in the exemplary embodiment, all of the television Ts, the television remote controller Tr, the air-conditioner Ac, and the air-conditioner operation panel Ar are specific targets included in the target object data 125. The image data 127 and the output data 128 of each of the specific targets are stored in the storage function unit 122 in advance.

The image determination unit 155 performs pattern matching, and determines that the image data 127 of the target object data 125, which is stored in advance, matches the images of the television Ts, the television remote controller Tr, the air-conditioner Ac, and the air-conditioner operation panel Ar, which are captured by the imaging unit 61. Accordingly, those objects are detected as the specific targets (see step S104 in FIG. 9).

Meanwhile, as for a target object, which is not included in the target object data 125 and is not regarded as a specific target (for example, a sofa in FIG. 10), similarly to the specific targets, coordinates of and distance to such an object are acquired through SLAM processing (see step S102 in FIG. 9). The position data 126 being three-dimensional information of the target object, which is not regarded as the specific target, is temporarily stored in the storage function unit 122 (see step S104 in FIG. 9). That is, the target acquisition unit 159 performs SLAM processing on each of the target objects included in the external scene captured by the imaging unit 61 to estimate the three-dimensional information.

Referring back to FIG. 9, in step S200, the coordinate acquisition unit 157 performs coordinate acquisition processing from step S201 to step S203 for acquiring a linear line along one direction determined in accordance with an instruction of the user and a cross point at a position closest to the user side from the cross points in the position range of the target object.

In step S201, the position detection unit 161 calculates a direction of the center axis of the target instruction device 300 based on a result of acceleration received by the target instruction device 300. The coordinate acquisition unit 157 determines the direction in which the user points through the target instruction device 300 based on the calculation result of the direction of the center axis of the target instruction device 300, which is acquired by the position detection unit 161.

In step S202, further, the coordinate acquisition unit 157 compares the distance to the target object, which is detected by the infrared sensor 67, and the distance to the above-mentioned cross point at the position closest to the user side. Then, processing for correcting the position of the cross point at the position closest to the user side is performed.

In step S203, the coordinate acquisition unit 157 reflects the result of the correction processing performed in step S202. Then, the linear line along the one direction determined in accordance with the instruction of the user through the target instruction device 300 and the target cross point being the cross point at the position closest to the user side (the HMD 100 side) among the cross points in the position range of the target object, which are acquired by the above-mentioned SLAM processing, are acquired. As described above, the user can specify the target object at a position closest to the user side, which includes the cross point in the position range, as a target to be controlled.

In step S204, by referring to the position information of the target cross point, which is acquired by the coordinate acquisition unit 157, the display control unit 147 performs control for displaying an image of a pointer marker at a position corresponding to the target cross point on the display image of the image display unit 20.

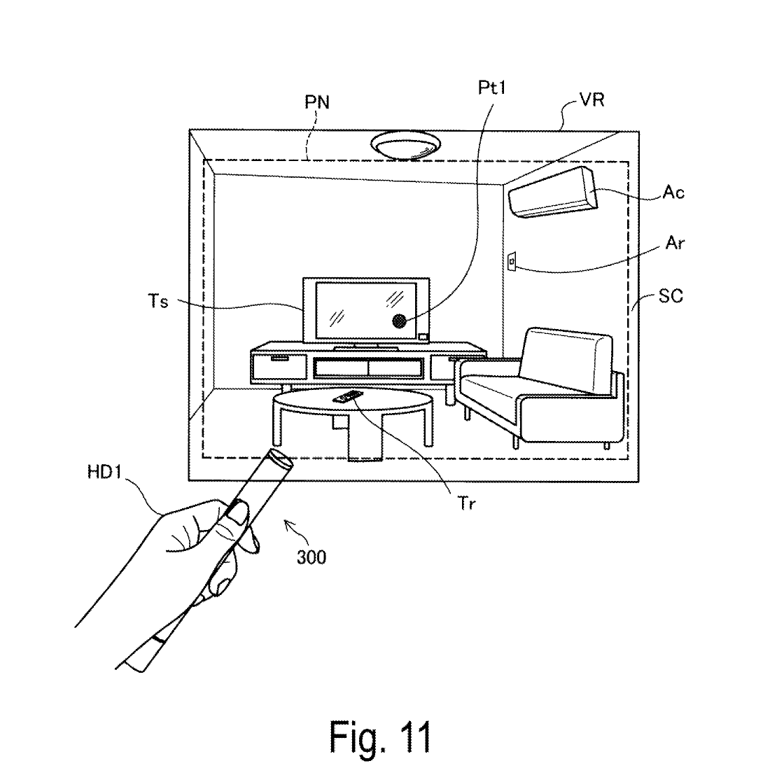

FIG. 11 is an explanatory diagram illustrating an example of the visual field VR in a case where the user uses the target instruction device 300. In FIG. 11, the target instruction device 300 held by the user with his or her left hand HD1 and a pointer marker Pt1 are illustrated. Through control performed by the display control unit 147, the pointer marker Pt1 is displayed at the position corresponding to the target cross point on the display image of the image display unit 20.

The position at which the pointer marker Pt1 is displayed is the position of the target cross point at the position closest to the user side (the HMD 100 side) among the cross points of the position range of the television Ts, which are acquired by the target acquisition unit 159, and the linear line along the one direction determined in accordance with the instruction of the user through the target instruction device 300. In FIG. 11, the pointer marker Pt1 is displayed in the position range of the television Ts, which is the specific target being the target object determined to match the image data 127 by the image determination unit 155. That is, in FIG. 11, the user specifies the television Ts being the specific target.

The image light introduced to both the eyes of the user forms an image on the retinas of the user. Accordingly, the user visually recognizes the image as augmented reality (AR) (the pointer marker Pt1 in FIG. 11). Further, the light passes from the external scene SC through the right light-guiding plate 26 and the left light-guiding plate 28, allowing the user to visually recognize the external scene SC. Thus, in a portion of the visual field VR where the image is displayed, the user can view the image in such a manner that the image overlaps the external scene SC. Further, in a portion of the visual field VR where the image is not displayed, the user can view only the external scene SC. With this, the user visually recognizes the target, which can be specified by operating the target instruction device 300, with the pointer marker Pt1, and then can select the specific target to be controlled.

Note that, the position data 126 on the target object, which is not regarded as the specific target (for example, a sofa in FIG. 11), is also acquired by the coordinate acquisition unit 157, and is temporarily stored in the storage function unit 122. Therefore, the pointer marker Pt1 can be displayed also on the surface of the target object, which is not regarded as the specific target.

Referring back to FIG. 9, in step S206, the coordinate acquisition unit 157 determines whether the target cross point is within the position range of the specific target. In a case where it is not determined that the target cross point is within the position range of the specific target (NO in step S206), the processing performed by the controller 10 returns to step S206. In a case where it is determined that the target cross point is within the position range of the specific target (YES in step S206), the controller 10 determines whether the confirmation operation by the user, which is described later, is performed (step S208). In a case where it is determined that the confirmation operation is performed (YES in step S208), the controller 10 performs display processing of step S300 (see FIG. 9). In a case where it is not determined that the confirmation operation is performed (NO in step S208), the processing performed by the controller 10 returns to step S206.

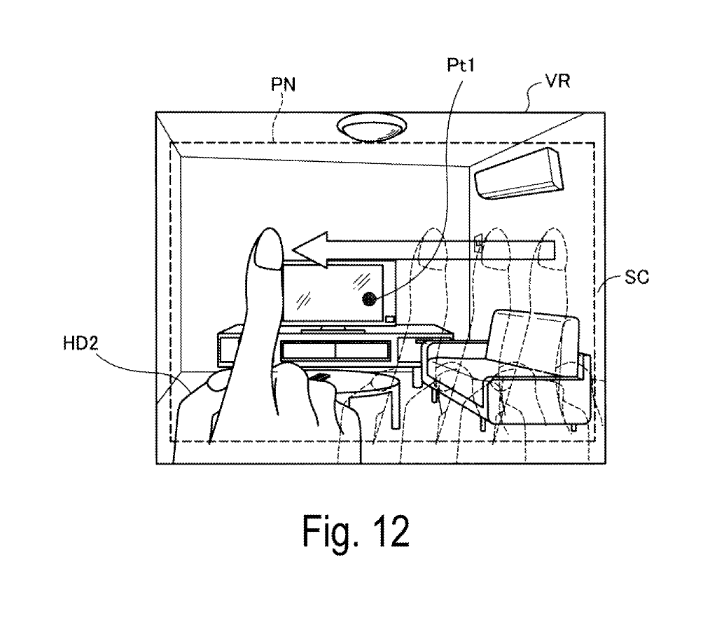

FIG. 12 is a schematic explanatory diagram illustrating a first confirmation operation by the user. Herein, a “confirmation operation” is change of a position of an object moved by the user, which is acquired by the imaging unit 61, and also indicates change of a position matching the data of the change of the position, which is stored in the storage function unit 122 being a storage unit in advance. When the confirmation operation is confirmed by the image determination unit 155, the display control unit 147 starts first specific display processing or second specific display processing described later, which are processing operations in accordance with the specific objects. An action of the user to perform a confirmation operation is also referred to as “to confirm”. In FIG. 12, there is illustrated a state in which a right hand HD2 of the user further overlaps the external scene in FIG. 11. The right hand HD2 of the user is positioned within 30 cm from the image display unit 20. The finger of the right hand HD2 of the user is moved in a horizontal direction (a left direction in FIG. 12) by the user. Note that, the “change of the position matching the data of the change of the position, which is stored in the storage function unit 122 in advance”, described above is not required to strictly match the data of the change of the position stored in advance. For example, in addition to a directional component in the horizontal direction, as the horizontal move, the data of the change of the position stored in the storage function unit 122 in advance may include an error of a directional component along a vertical direction and an error of a directional component in a depth direction of the HMD 100.

In the exemplary embodiment, the target object data 125 includes an image of the finger of the user as an object stored in advance. Further, the target object data 125 includes data of change of a position of the finger of the user in the horizontal direction as the data of the change of the position of the object. By referring to those data, the image determination unit 155 performs pattern matching to detect the horizontal move of the finger of the user as a gesture.

Note that, in FIG. 12, a locus of the move of the finger of the user is indicated with the broken lines. In a case where the user specifies the specific target, the image display unit 20 displays the locus of the finger moving on the image display unit 20 on the display screen in advance. In this manner, a guidance of an operation may be given to the user.

The coordinate acquisition unit 157 causes the imaging unit 61 to acquire the position range of the right hand HD2 of the user. The coordinate acquisition unit 157 recognizes the position range of the right hand HD2 of the user at a position within 30 cm from the image display unit 20 (hereinafter, also referred to as a “first range”), and the image determination unit 155 detects the horizontal move of the finger of the user. In such case, the controller 10 performs the first specific display processing described later. That is, the horizontal move of the finger of the user is a confirmation operation in the exemplary embodiment. With this, after the user specifies the television Ts as the target object, the user can perform control of the television Ts being the specific object in an easier manner.

Furthermore, in the exemplary embodiment, the horizontal move of the position of the finger of the user at the position within 30 cm from the image display unit 20 is also referred to as the “first confirmation operation”. In the exemplary embodiment, when the image determination unit 155 recognizes the first confirmation operation, control of each text image, that is, control of a virtual object, is started. With this, after the target object is specified, the user determines whether the first confirmation operation being the change of the position of the target object is performed or not. Accordingly, whether control of the specific object is performed or not can be determined.

Referring back to FIG. 9, in step S300, when the target cross point is within the position range of the specific object, the image determination unit 155 recognizes the first confirmation operation by the user. Then, the display control unit 147 displays an image being a first display of the output data 128 is displayed as the virtual object on the image display unit 20. Herein, the term “first specific display processing” indicates processing performed by the display control unit 147 for displaying the first display on the screen of the image display unit 20.

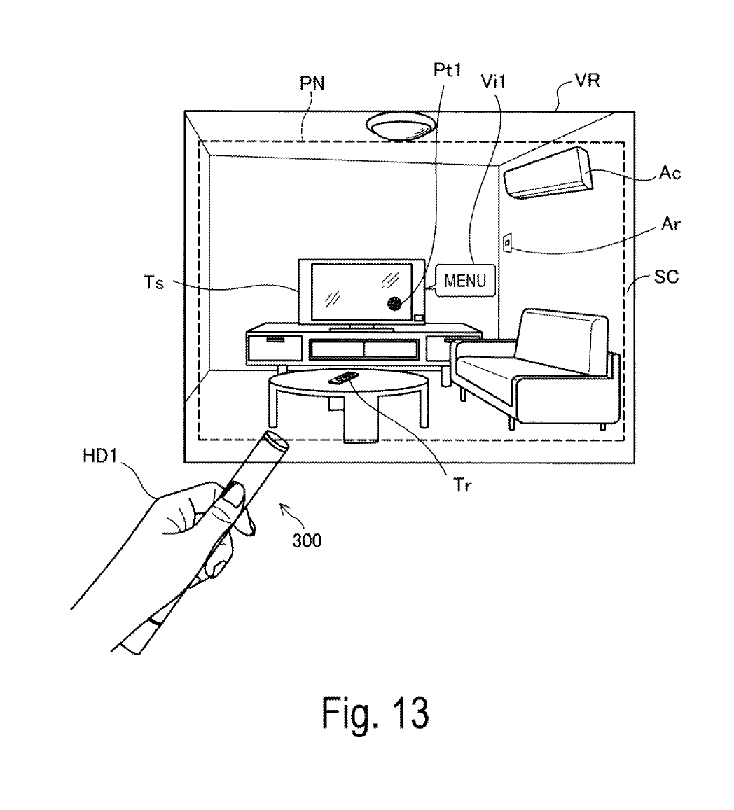

FIG. 13 is an explanatory diagram illustrating an example of the maximum region PN under a state where the imaging control unit 149 performs the first specific display processing. In FIG. 13, a virtual object Vi1 is displayed in the vicinity of the television Ts being the specific target. The virtual object Vi1 is an example of a text image included in the output data 128. In the exemplary embodiment, the virtual object Vi1 is an image being the first display corresponding to the television Ts being the specific target.

In the exemplary embodiment, the display control unit 147 performs image maintain processing for maintaining the image of the virtual object displayed on the image display unit 20 under a state of being displayed for a predetermined time period. In the exemplary embodiment, the image maintain processing is performed for all the virtual objects displayed on the image display unit 20 through control performed by the display control unit 147. After the predetermined time period elapses, the image maintained under the state of being displayed by the image maintain processing is erased from the screen of the image display unit 20 by the display control unit 147. This predetermined time period may be a time period starting from the time when the virtual object is displayed, or may be counted from the time when the target cross point goes off of the virtual object.

Referring back to FIG. 9, in step S301, the range formation unit 163 of the coordinate acquisition unit 157 performs, on the virtual object, range formation processing for providing a position range corresponding to a size of the frame image of the virtual object. The coordinate acquisition unit 157 generates a position range of the virtual object at a position at which the virtual object is displayed, and adds the position range to the three-dimensional information acquired by the imaging unit 61. With this, the three-dimensional information includes the position range of the virtual object. Therefore, the target cross point can be displayed in the position range of the virtual object displayed on the image display unit 20, and the virtual object can be regarded as the target object (the specific target). In this manner, the controller 10 can be caused to perform the second specific display processing described later.

In step S302, the controller 10 performs control for confirming whether the target cross point is within the position range of the virtual object. In a case where it is not determined that the target cross point is within the position range of the virtual object (NO in step S302), the processing performed by the controller 10 proceeds to step S500. In a case where it is determined that the target cross point is within the position range of the virtual object (YES in step S302), the processing proceeds to step S304 described later.

At this time, the image determination unit 155 performs image analysis on an image including the virtual object, which is generated by the display control unit 147, and extracts a portion in which the specific target other than the virtual object and the virtual object visually overlap each other on the display image including the position range of the virtual object (hereinafter, referred to as an “overlapping portion”).

The range formation unit 163 generates a position range capable of being selected for either the specific target or the virtual object, as a position range of the overlapping portion in the position range of the virtual object. With this, even when the virtual object and the specific target overlap each other, the user can select and specify either the virtual object or the specific target.

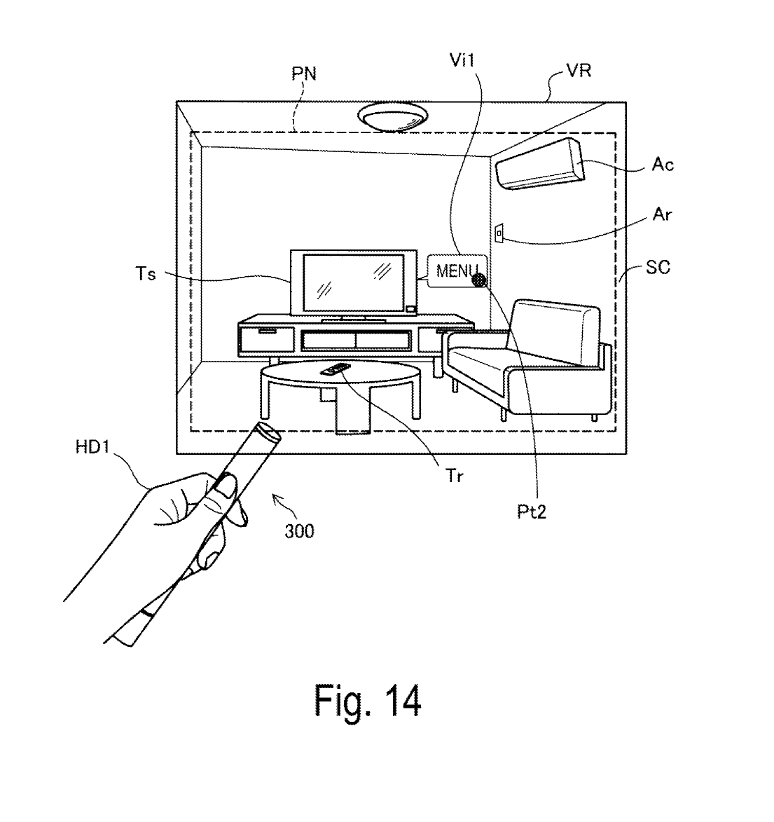

FIG. 14 is an explanatory diagram illustrating an example of the maximum region PN in which a pointer marker Pt2 is displayed on the virtual object Vi1. The virtual object Vi1 is an image displayed on the image display unit 20, and cannot be recognized by the imaging unit 61. The range formation unit 163 of the coordinate acquisition unit 157 performs, on the virtual object Vi1, the range formation processing for providing a position range corresponding to a size of the frame image of the virtual object Vi1.

In FIG. 14, the position at which the pointer marker Pt2 is displayed is a position of the target cross point in the position range of the virtual object Vi1, which is provided by the range formation unit 163. That is, in FIG. 14, there is illustrated a state in which the user specifies the virtual object Vi1 being the specific object.

Referring back to FIG. 9, in step S304, the coordinate acquisition unit 157 determines whether the target cross point is within the position range of the above-mentioned overlapping portion. In a case where it is not determined that the target cross point is within the position range of the overlapping portion (NO in step S304), the processing performed by the controller 10 proceeds to step S308. In a case where it is determined that the target cross point is within the position range of the overlapping portion (YES in step S304), the processing performed by the controller 10 proceeds to step S306.

In step S306, the image determination unit 155 determines whether the first confirmation operation by the user is recognized. In a case where the first confirmation operation by the user is recognized (YES in step S306), the processing performed by the controller 10 returns to step S300. Then, the first specific display processing for the specific object overlapping the virtual object is performed. In a case where the first confirmation operation by the user is not recognized (NO in step S306), the processing of the controller 10 proceeds to step S308.

In step S308, the image determination unit 155 determines whether the second confirmation operation described below performed by the user is recognized. In a case where the second confirmation operation by the user is recognized (YES in step S308), the processing of the controller 10 proceeds to step S310. In a case where the second confirmation operation by the user is not recognized (NO in step S308), after the predetermined time period elapses, the virtual object maintained under the state of being displayed by the image maintain processing is erased from the screen of the image display unit 20 by the display control unit 147 (step S500).

As described above, in step S306 and step S308, in a case where the target cross point is within the position range of the overlapping portion, the user selectively performs any of the first confirmation operation and the second confirmation operation. With this, in a case where the confirmation operation is performed under a state in which the distance from the HMD 100 is within the first range (that is, a case where the first confirmation operation is performed), the first specific display processing corresponding to the specific object being the target object is started. In a case where the confirmation operation is performed at a position away from the first range (that is, a case where the second confirmation operation is performed), the second specific display processing corresponding to the virtual object being the image is started. Therefore, even when the target object to be controlled and the virtual object being the image overlap each other, the user can specify either the target object or the virtual object to start the control.

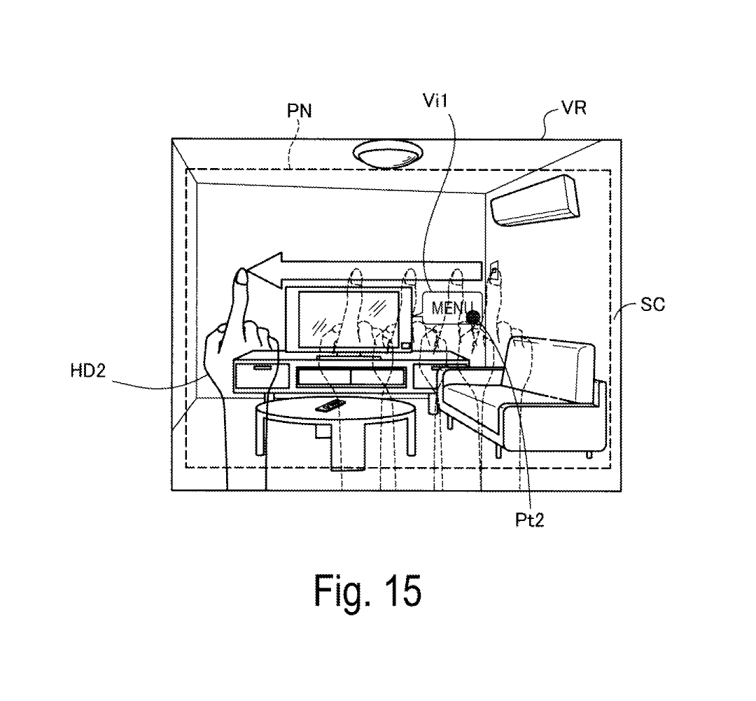

FIG. 15 is a schematic explanatory diagram illustrating the second confirmation operation by the user. In FIG. 15, there is illustrated a state in which a right hand HD2 of the user further overlaps the external scene in FIG. 14. The right hand HD2 of the user is located away from the image display unit 20 by a distance of 30 cm or more, and is at a position located away from the first range. The user moves a finger of the right hand HD2 in the horizontal direction (the left direction in FIG. 15).

As described above, the image determination unit 155 performs pattern matching with reference to the image of the finger of the user, which is stored in the target object data 125 in advance, and the data of the change of the position of the finger of the user in the horizontal direction. In this manner, the horizontal move of the finger of the user is detected as the confirmation operation.

The coordinate acquisition unit 157 also causes the imaging unit 61 to acquire the position range of the right hand HD2 of the user. In a case that the coordinate acquisition unit 157 recognizes the position range of the right hand HD2 of the user at a position away from the image display unit 20 by 30 cm or more, and the image determination unit 155 detects the confirmation operation by the user, the controller 10 performs display processing for further displaying a second display image corresponding to the virtual object Vi1 being the first display image (hereinafter, referred to as the “second specific display processing”). In the exemplary embodiment, under the state in which the distance from the image display unit 20 is 30 cm or more, the action of the user moving the position of the finger in the horizontal direction is also referred to the “second confirmation operation”. In the exemplary embodiment, when the image determination unit 155 recognizes the second confirmation operation, the second specific display processing being control of the virtual object is started.

Referring back to FIG. 9, in step S310, the display control unit 147 determines whether the second specific display processing is performed. More specifically, in step S308, it is determined whether the control in association with the virtual object confirmed by the user is the second specific display processing. In a case where the control in association with the virtual object confirmed by the user is the second specific display processing (YES in step S310), the display control unit 147 performs the second specific display processing in step S400. After that, the processing performed by the controller 10 returns to step S301, and the range formation unit 163 provides the virtual object displayed through the second specific display processing with a position range through the range formation processing. In a case where the control in association with the virtual object confirmed by the user is not the second specific display processing (NO in step S310), the controller 10 performs control in association with the virtual object (step S312).

In step S600, the controller 10 confirms whether to terminate the control. For example, in a case where the user cuts the power supply to the imaging unit 61, the control performed by the controller 10 is terminated (YES in step S600). In a case where the control performed by the controller 10 is not terminated (NO in step S600), the processing performed by the controller 10 returns to step S206.

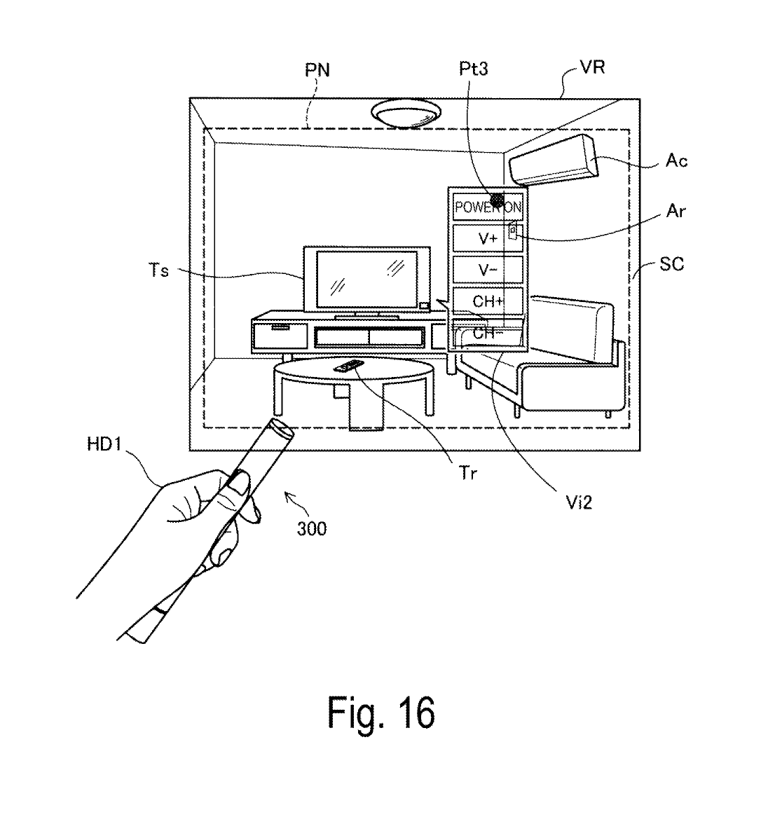

FIG. 16 is an explanatory diagram illustrating an example of the maximum region PN under a state in which the imaging control unit 149 performs the second specific display processing. In FIG. 16, through the second specific display processing, a virtual object Vi2 being a second display is displayed in the vicinity of the television Ts being the specific object. In other words, in FIG. 16, there is illustrated a state after the user performs the second confirmation operation under a state where the pointer marker Pt2 being the target cross point is displayed in the position range of the virtual object Vi1 (see FIG. 15).

The virtual object Vi2 is an image being the second display corresponding to the television Ts being the specific object in the exemplary embodiment. In the exemplary embodiment, the virtual object Vi2 is displayed by the control performed by the display control unit 147 under a state of passing through the external scene SC (for example, the air-conditioner operation panel Ar in FIG. 16). In the exemplary embodiment, the second display is an image associated with the virtual object of the first display, and is displayed when the user specifies the first display to perform the second confirmation operation. When the target cross point is in the position range of the virtual object Vi1, the controller 10 recognizes the second confirmation processing by the user. Accordingly, the display control unit 147 performs the second specific display processing for displaying the image being the second display as the virtual object on the image display unit 20.

In FIG. 16, a pointer marker Pt3 is displayed at a position corresponding to the text image “Power ON” in the position range of the virtual object Vi2. At this time, the user performs the second confirmation operation. When the operation is recognized by the controller 10, the communication control unit 153 controls the wireless communication unit 117 to perform control for turning the power of the television Ts being a control device into an on state.

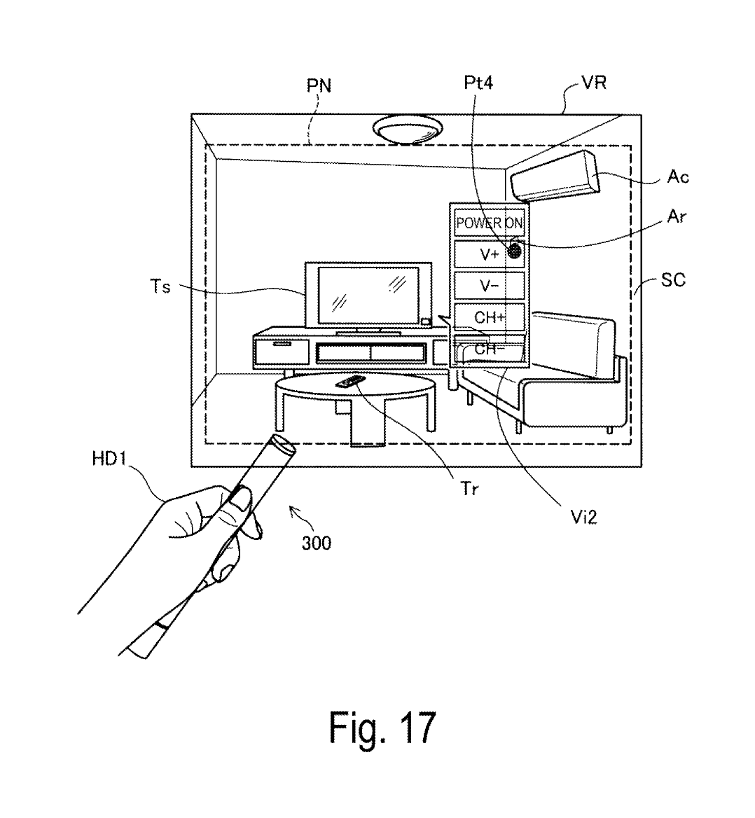

FIG. 17 is an explanatory diagram illustrating an example of the maximum region PN under a state in which a pointer marker Pt4 is displayed. In FIG. 17, a part of the text image “V+” in the position range of the virtual object Vi2 and the air-conditioner operation panel Ar being another specific object overlap each other. That is, this overlapping portion is a position range of the above-mentioned overlapping portion. In FIG. 17, the pointer marker Pt4 is displayed in this position range of the overlapping portion.

At this time, the user performs the second confirmation operation. When the image determination unit 155 recognizes the operation, the controller 10 starts control of the virtual object Vi2. More specifically, when the controller 10 recognizes the second confirmation operation, the communication control unit 153 controls the wireless communication unit 117 to cause the television Ts being a control device to perform control corresponding to “V+” (turning up the volume).

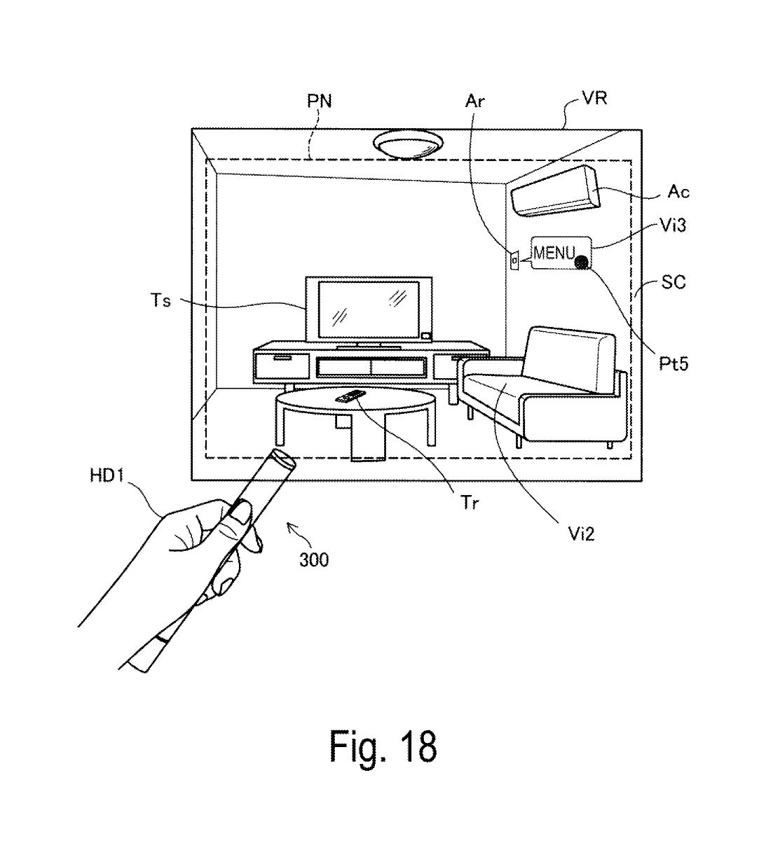

FIG. 18 is an explanatory diagram illustrating an example of the visual field VR in a case where control corresponding to the air-conditioner operation panel Ar is performed. FIG. 18 illustrates that under a state in which the pointer marker Pt4 is displayed in the position range of the overlapping portion (see FIG. 17), the user performs the first confirmation operation. When the image determination unit 155 recognizes the first confirmation operation by the user, the controller 10 starts control corresponding to the air-conditioner operation panel Ar being the specific object. Control corresponding to the air-conditioner operation panel Ar is control for displaying a virtual object Vi3 of “menu” being the first display.

As described above, the HMD 100 according to the exemplary embodiment can display the virtual object corresponding to the target object at the position closest to the user side on the indicated linear line in response to the instruction of the user with the target instruction device 300. Therefore, the user specifies the target object to be controlled at his or her own will, and the image corresponding to the target object can be displayed on the image display unit. In the case where the direction indicated by the user is a linear line along one direction as in the exemplary embodiment, the user can specify the target object more accurately as compared to the mode in which the user specifies a target object by directly placing a visually small target object on the display image of the image display unit 20 with the finger of the user.

Further, with the HMD 100 according to the exemplary embodiment, the virtual object displayed on the image display unit 20 is provided with a position range. The user can specify the virtual object by pointing to the virtual object provided with the position range, and accordingly, can cause the image corresponding to the virtual object to be displayed. Therefore, the user specifies the virtual object to be controlled at his or her own will, and the image corresponding to the virtual object can be displayed on the image display unit 20.

Further, with the HMD 100 according to the exemplary embodiment, when the confirmation operation by the user is within the first range, the display processing for the specific object is started. When the operation is away from the first range, the second display processing for the image or the virtual object is started. Therefore, even when the target object to be controlled and the virtual object or the image overlap each other, the user can specify either the target object or the virtual object to start the control.

### B. Other Exemplary Embodiments

(B1) In the above-mentioned exemplary embodiment, the HMD 100 includes the imaging unit 61. However, the HMD may not include an imaging unit. In such case, for example, the following modes may be adopted. That is, the position range of the target object may be acquired by other devices capable of causing the HMD to measure a distance from the image display unit to the target object, such as a depth sensor, an infrared sensor, an ultraviolet sensor, or an ultrasonic wave sensor. Alternatively, the data on the position range may be received from an independent device that acquires the position range of the target object.

(B2) In the above-mentioned exemplary embodiment, the virtual object being the image corresponding to the specific object is formed of a text image and a frame image including a region corresponding to a size of the display region of the text image. However, the virtual object is not limited to such an image. For example, various images such as an image for decorating the specific object and images of accessories may be applied. In this mode, the target object other than the control device can be specified, and the image corresponding to the target object can be displayed.

(B3) In the above-mentioned exemplary embodiment, the image determination unit 155 of the controller 10 performs, on the target object, pattern matching being the image recognition processing for making comparison with the images stored in the target object data 125 in advance. However, for example, the controller 10 recognizes the target object through processing such as image feature extraction utilizing deep learning in place of the pattern matching.

(B4) In the above-mentioned exemplary embodiment, the target acquisition unit 159 analyzes the image acquired from the imaging unit 61 and performs SLAM processing. Alternatively, the target acquisition unit may adopt other processes than SLAM processing. The position range of the target object may be acquired by various processing operations such as three-dimensional space recognition (marker-less AR) for forming a three-dimensional space through use of image characteristic points of an image acquired by the imaging unit, and stereo vision or three-dimensional point groups (point crowd) for forming a three-dimensional space from stereo images captured by a plurality of imaging units. Even in this mode, effects similar to those in the above-mentioned exemplary embodiment can be achieved.

(B5) In the above-mentioned exemplary embodiment, the horizontal move of the finger of the user is a confirmation operation. Alternatively, the change of the position of the object moved by the user, which is acquired by the imaging unit, is not limited to the move of the finger of the user, and may be other parts of the body of the user. The change of the position may be the move of an object other than the user, caused by the user. Even in this mode, effects similar to those in the above-mentioned exemplary embodiment can be achieved.

(B6) In the above-mentioned exemplary embodiment, the controller 10 recognizes the position within 30 cm from the image display unit 20 as the first range. Alternatively, the first range is not limited to be within 30 cm. The first range may be located away from the image display unit by a distance of 20 cm or less. Even in this mode, effects similar to those in the above-mentioned exemplary embodiment can be achieved.

(B7) In the above-mentioned exemplary embodiment, the controller 10 sets the position located 30 cm or more away from the image display unit 20 as a distance for recognizing the second confirmation operation. Alternatively, the distance for recognizing the confirmation operation is not limited to 30 cm. The distance for recognizing the confirmation operation may be limited to a range having a distance from the image display unit, which is from 30 cm to 40 cm, or may be set as a position located 20 cm or more away from the image display unit 20. Even in this mode, effects similar to those in the above-mentioned exemplary embodiment can be achieved.

(B8) In the above-mentioned exemplary embodiment, the range formation unit 163 provides the virtual object, which is displayed on the image display unit 20, with a position range corresponding to a size of the frame image of the virtual object. Alternatively, the virtual object may not be provided with a position range. In this mode, the virtual object corresponding to the specific object is displayed, and the virtual object is not specified. Even in this mode, the user specifies the target object to be controlled at his or her own will, and the image corresponding to the target object can be displayed on the image display unit 20.

(B9) In the above-mentioned exemplary embodiment, when the confirmation operation by the user is within the first range, the display processing for the specific object is started. When the operation is away from the first range, the second display processing for the image or the virtual object is started. Alternatively, when the confirmation operation is within the first range, the second display processing for the image or the virtual object may be started. When the confirmation operation is at the position away from the first range, the display processing for the specific object may be started. Even in this mode, the user specifies the target object to be controlled at his or her own will, and the image corresponding to the target object can be displayed on the image display unit 20.

(B10) In the above-mentioned exemplary embodiment, the coordinate acquisition unit 157 calculates a linear line along the one direction determined in accordance with the instruction by the user through the target instruction device 300, and a target cross point at a position closest to the user side among the cross points in the position range of the target object acquired by the above-mentioned SLAM processing. Alternatively, the linear line along one direction set in accordance with the instruction by the user through the target instruction device is not limited to a line. For example, the user may indicate a direction with a shape including a predetermined range such as a columnar shape. In this mode, the coordinate acquisition unit is only required to acquire a direction indicated by the shape including a predetermined range in accordance with the instruction by the user and the instructed region being a portion common with the position range of the target object.

(B11) In the above-mentioned exemplary embodiment, the image determination unit 155 and the coordinate acquisition unit 157 are provided to the controller 10. However, the present invention can be achieved with an image processing system, a camera, and an encoder, which are independently provided as other devices. For example, the image recognition processing of pattern matching and SLAM processing may be performed by cloud computing, a server, a host computer, or a smartphone via a wireless communication line.

(B12) In the above-mentioned exemplary embodiment, when the image determination unit 155 detects the horizontal move of the finger of the user as a confirmation operation, the controller 10 performs the first specific display processing. Alternatively, the confirmation operation is not limited to the horizontal move of the finger of the user. For example, in place of the finger of the user, various confirmation operations may be adopted. For example, a pointer marker on an image of the target instruction device may be moved in right and left directions at a predetermined speed. The user may tap the virtual object with the finger. The user may press a switch of the target instruction device. The user may swing the finger in the right and left directions. The user may vibrate the finger of the hand holding the target instruction device to perform double-click under a state in which a pointer marker is superimposed on the virtual object.

(B13) In the above-mentioned exemplary embodiment, the output unit 302 of the target instruction device 300 includes the infrared LED light source. Alternatively, the output unit of the target instruction device may include, for example, a laser diode (LD) and a transmitter transmitting ultrasonic waves. In this mode, it is preferred that the HMD main body includes a receiver in accordance with a light source and the like included in the target instruction device.

(B14) In the above-mentioned exemplary embodiment, the infrared sensor 67 includes the position sensitive detector (PSD). In place of this, a solid-state imaging device such as a charge coupled devices (CCD) or a CMOS may be included.

### C. Other Aspects

The invention is not limited to the exemplary embodiments described above, and can be achieved in various aspects without departing from the gist of the invention. For example, the present invention can be achieved with the following aspects. Technical features in the exemplary embodiments corresponding to the technical features in the aspects below can appropriately be replaced or combined to address some or all of the above-described issues or to achieve some or all of the above-described effects. Additionally, when the technical features are not described herein as essential technical features, such technical features may be deleted appropriately.

(1) According to an aspect of the present invention, a transmission-type head mounted display apparatus is provided. The transmission-type head mounted display apparatus includes an image display unit configured to transmit an external scene and display an image on the external scene, and a controller configured to control the image display unit. The controller is configured to perform target acquisition processing for acquiring a position range of one or more target objects included in the external scene, coordinate acquisition processing for acquiring a direction set in accordance with an instruction by a user and an instruction region positioned closest to the user among instruction regions which are portions common with the position range of one or more target objects, and display processing for allowing display of an image associated with a specific object being the target object, the position range of which includes the instruction region, on the image display unit. With the transmission-type head mounted display apparatus according to the above-mentioned aspect, the image according to the target object at the position closest to the user side on the linear line indicated in accordance with the instruction by the user can be displayed. Therefore, the user specifies the target object to be controlled at his or her own will, and the image associated with the target object can be displayed on the image display unit. For example, in the case where the direction indicated by the user is a linear line, the user can specify the target object more accurately as compared to the mode in which the user specifies a target object by directly placing a visually small target object on an image with the finger of the user.

(2) In the transmission-type head mounted display apparatus according to the above-mentioned aspect, the imaging unit configured to capture an image of the external scene may be included. The controller is configured to further perform image determination processing for determining whether an image of the target object included in the external scene, which has been captured, matches a stored image stored in a storage unit in advance. The display processing includes specific display processing for displaying, on the image display unit, a virtual object associated with an image of the specific object as an image corresponding to the specific object, when determination is made that the image of the specific object matches the stored image by the image determination processing. With the transmission-type head mounted display apparatus according to the above-mentioned mode, image determination is performed on the target object specified by the user. The controller can cause the virtual object associated with the target object, which is specified by the user, to be displayed on the image display unit. Therefore, for example, display of the name of the target object on the displayed virtual object enables the user to reliably specify the target object.

(3) In the transmission-type head mounted display apparatus according to the above-mentioned mode, the controller may further perform range formation processing for providing the virtual object with the position range so that the virtual object displayed on the image display unit is regarded as the target object to perform the display processing. The controller performs second display processing for further displaying an image corresponding to the virtual object on the image display unit, with the virtual object, the position range of which includes the instruction region, being regarded as the specific object when the instruction region acquired by the coordinate acquisition processing is included in the position range of the virtual object, which is provided by the range formation processing. With the transmission-type head mounted display apparatus according to the above-mentioned aspect, the virtual object displayed on the image display unit is provided with a position range. The user can specify the virtual object by indicating the virtual object provided with the position range, and accordingly, can cause the image associated with the virtual object to be displayed. Therefore, the user specifies the virtual object to be controlled at his or her own will, and the image associated with the virtual object can be displayed on the image display unit.

(4) In the transmission-type head mounted display apparatus according to the above-mentioned mode, the controller may start the display processing or the second display processing corresponding to the specific object when a change of a position of an object moved by the user, which is acquired by the imaging unit, matches a change of a position stored in the storage unit in advance. With the transmission-type head mounted display apparatus according to the above-mentioned aspect, the change of the position of the target object is determined by image determination processing. Accordingly, the display processing for the specific object or the second display processing can be started. Therefore, after the target object is specified, the user determines whether the change of the position of the target object is performed or not. Accordingly, whether control of the specific object is performed or not can be determined.

(5) In the transmission-type head mounted display apparatus according to the above-mentioned mode, the object moved by the user may be a finger of the user. With the transmission-type head mounted display apparatus according to the above-mentioned aspect, with a move of a hand of a person in the horizontal direction, the controller starts control. Therefore, after the user specifies the target object, the user can perform control of the specific object in an easier manner.

(6) In the transmission-type head mounted display apparatus according to the above-mentioned aspect, the controller may further perform image maintain processing for maintaining the image displayed by the display processing or the second display processing under a state of being displayed for a predetermined period. The controller is configured to, when the image maintained under a state of being displayed by the image maintain processing and the target object overlap, start the display processing corresponding to the target object when the finger is moved in a horizontal direction in a region displayed on the image display unit under a state in which the distance from the image display unit is within a first range. The controller is configured to start control including the second display processing corresponding to the image, the display of which is maintained, when the finger is moved in the horizontal direction in the region displayed on the image display unit under a state in which the finger is at a position distant, over the first range, from the image display unit. With the transmission-type head mounted display apparatus according to the above-mentioned aspect, when the change of the position of the finger of the user is within the first range, the display processing for the specific object is started. When the change of the position of the finger of the user is at a position away from the first range, the second display processing for the image or the virtual object is started. Therefore, even when the target object subjected to control and the virtual object or the image overlap each other, the user can specify either the target object or the virtual object to start the control.

(7) In the transmission-type head mounted display apparatus according to the above-mentioned aspect, the first range may be positioned within 30 cm from the image display unit.

The present invention can be achieved in various modes other than a transmission-type head mounted display apparatus. For example, the present invention can be achieved in a manufacturing method of the transmission-type head mounted display apparatus and a storage medium, which is not temporary and stores a program for the transmission-type head mounted display apparatus (non-transitory storage medium).

The present application is based on and claims priority from JP Application Serial Number 2018-050596, filed Mar. 19, 2018, the disclosure of which is hereby incorporated by reference herein in its entirety.

What is claimed is:

1. A transmission-type head mounted display apparatus comprising:
an image display unit configured to transmit an external scene and display an image on the external scene; and
a controller configured to control the image display unit, wherein the controller is configured to perform:
target acquisition processing for acquiring a position range of one or more target objects included in the external scene;
coordinate acquisition processing for acquiring a direction set in accordance with an instruction by a user and an instruction region positioned closest to the user among instruction regions which are portions common with the position range of the one or more target objects; and
display processing allowing an image corresponding to a specific object being the target object, the position range of which includes the instruction region, to be displayed on the image display unit.

2. The transmission-type head mounted display apparatus according to claim 1, further comprising
an imaging unit configured to capture an image of the external scene, wherein
the controller is configured to further perform image determination processing for determining whether an image of the target object included in the external scene, which has been captured, matches a stored image stored in a storage unit in advance, and
the display processing includes specific display processing for displaying, on the image display unit, a virtual object associated with an image of the specific object as an image corresponding to the specific object, when determination is made that the image of the specific object matches the stored image by the image determination processing.

3. The transmission-type head mounted display apparatus according to claim 2, wherein
the controller is configured to further perform:
range formation processing for providing the virtual object with the position range so that the virtual object displayed on the image display unit is regarded as the target object to perform the display processing; and
second display processing for further displaying an image corresponding to the virtual object on the image display unit, with the virtual object, the position range of which includes the instruction region, being regarded as the specific object when the instruction region acquired by the coordinate acquisition processing is included in the position range of the virtual object, which is provided by the range formation processing.

4. The transmission-type head mounted display apparatus according to claim 3, wherein
the controller is configured to
start the display processing or the second display processing corresponding to the specific object when a change of a position of an object moved by the user, which is acquired by the imaging unit, matches a change of a position stored in the storage unit in advance.

5. The transmission-type head mounted display apparatus according to claim 4, wherein
the object moved by the user is a finger of the user.

6. The transmission-type head mounted display apparatus according to claim 5, wherein
the controller is configured to
further perform image maintain processing for maintaining the image, which is displayed by the display processing or the second display processing, under a state of being displayed for a predetermined period,
the controller is configured to
when the image maintained under a state of being displayed by the image maintain processing and the target object overlap,
start the display processing corresponding to the target object when the finger is moved in a horizontal direction in a region displayed on the image display unit under a state in which a distance from the image display unit is within a first range, and
start control including the second display processing corresponding to the image, the display of which is maintained, when the finger is moved in the horizontal direction in the region displayed on the image display unit under a state in which the finger is at a position distant, over the first range, from the image display unit.

7. The transmission-type head mounted display apparatus according to claim 6, wherein
the first range is a position within 30 cm of the image display unit.

8. A method of controlling a transmission-type head mounted display apparatus mounted on a head, and including an apparatus main body including an image display unit configured to transmit an external scene and display an image on the external scene, the method comprising:
acquiring a position range of one or more target objects included in the external scene;
acquiring a direction set in accordance with an instruction by a user and an instruction region positioned closest to the user among instruction regions which are portions common with the position range of the one or more target objects; and
displaying, on the image display unit, an image corresponding to a specific object being the target object, the position range of which includes the instruction region.

9. A non-transitory computer-readable storage medium storing a program for controlling a transmission-type head mounted display apparatus mounted on a head, and including an apparatus main body including an image display unit configured to transmit an external scene and display an image on the external scene, the program realizing functions of:
acquiring a position range of one or more target objects included in the external scene;
acquiring a direction set in accordance with an instruction by a user and an instruction region positioned closest to the user among instruction regions which are portions common with the position range of the one or more target objects; and
displaying, on the image display unit, an image corresponding to a specific object being the target object, the position range of which includes the instruction region.
